(19) United States
(12) Patent Application Publication
(10) Pub. No.: US 2016/0042388 A1
(43) Pub. Date: Feb. 11, 2016

(54) TRACKING AND ANALYZING MOBILE DEVICE ACTIVITY RELATED TO MOBILE DISPLAY CAMPAIGNS

(71) Applicant: Somo Innovations Ltd, London (GB)

(72) Inventors: Edward Chater, London (GB); Oscar Darwin, London (GB)

(21) Appl. No.: 14/820,930

(22) Filed: Aug. 7, 2015

Related U.S. Application Data
(60) Provisional application No. 62/034,726, filed on Aug. 7, 2014.

(51) Int. Cl. G06Q 30/02; H04W 8/18; H04W 24/08; H04L 29/08

(52) U.S. Cl. CPC G06Q 30/0246; H04L 67/22; H04W 8/183; H04W 24/08

(57) ABSTRACT

When an in-app event, which may be any activity that occurs within a mobile application, is performed, a server may receive in-app data including a device identifier associated with a device from which the in-app event originated. The server may generate all permutations of the received device identifier, including all hashed versions of the device identifier, and store all device identifiers associated with the device in a data record. Any other click events with click data including a device identifier that matches any of the device identifiers in the data record can be recognized as originating from the same device. Hence, mobile activity may be tracked to the actual device at which the activity occurred, despite existing device identifier fragmentation. This can enable more effective analysis, such as click fraud analysis and click path analysis, of click traffic for display campaigns.

### CROSS-REFERENCES TO RELATED APPLICATIONS

The present application claims priority from and is a non-provisional application of U.S. Provisional Application No. 62/034,726, entitled “Tracking and Analyzing Mobile Device Activity Related to Mobile Advertising Campaigns,” filed Aug. 7, 2014, the entire contents of which are herein incorporated by reference for all purposes.

### FIELD

The present disclosure relates to systems and methods involving tracking and analyzing mobile device activity related to mobile display campaigns.

### BACKGROUND

In the mobile advertising industry, advertisers (i.e. buyers) rely on media partners (i.e. sellers) to report accurate numbers of how many of the advertiser's ads are served in response to authentic mobile traffic by the media partners, and thus, what compensation the advertiser owes to the media partner. There is a technical problem in the industry, however, of click fraud, in which a person, automated script, or computer program imitates a legitimate user of a web browser/application clicking on a display campaign (e.g., advertisement), for the purpose of generating a charge per click without having actual interest in the target of the ad's link. There is currently little that advertisers can do to distinguish between legitimate mobile traffic and fraudulent clicks, and are therefore generally stuck with a media partner's bill for all clicks, with no room for recourse. In any given ad campaign, advertisers may be paying for clicks/installs that were not genuine, which has a negative impact on the campaign's return on investment. Such a problem relates to the technical ability to track user interactions on various devices.

Another issue that advertisers face in the mobile industry is in optimizing campaigns. Advertisers desire to have tools of visibility that give them confidence to spend more money in mobile campaigns, and then to optimize and improve results based on the data collected. Currently, however, analytics tools only track converting clicks, which make up the clicks that occur directly before an installation of a software application or other event of interest. These tools do not show any information about clicks leading up to the converting click. Again, there is a technical problem to achieve the ability to measure user interactions on various devices.

The mobile ad campaign tracking problems outlined above stem from the inability to utilize cookies for mobile display campaign tracking and the fragmentation problems associated with an unstandardized market. Since cookies cannot be utilized for tracking of mobile display campaigns, alternative methods are desired. One such alternative method is to record and track device identifiers (device IDs). The major problem with this approach, however, is that different media partners utilize different types of device identifiers (e.g. IDFAs that may be hashed using different coding methods, not hashed IDFAs, third party IDs, MAC address, etc.), so a single device may be associated with many different forms of device identifiers. This makes it difficult to track the clicking activity of each device that is associated with a particular display campaign. The issue is exacerbated as time passes, since there is further fragmentation of device IDs that media partners pass on, as well as an increase in the number of devices. This makes it even more difficult to monitor the quality of click activity, and more importantly, to have a solution.

Therefore, it is desirable to provide systems and methods that address fragmentation issues associated with cookie-less tracking of display campaigns in the mobile environment, so that fraud can be identified and important visibility into consumer behavior can be achieved.

### SUMMARY

Embodiments of the present invention provide systems and methods for tracking and analyzing activity on mobile devices. In one embodiment, a marketing attribution SDK and tracking URLs are used to track click events and SDK events related to certain mobile advertising campaigns. Collected data may be used to create a master identifier, which can be used to match click events and SDK events to specific devices. From the gathered intelligence, certain modeling applications may be run to provide insights into mobile advertising campaigns; such modeling applications may include but are not limited to click fraud analysis and click path analysis.

According to one embodiment of the invention, a server computer can receive data related to click events at a plurality of mobile devices, the click events including clicking on a link associated with a plurality of display campaigns. The click data of each click event can include at least one device identifier of a mobile device and a campaign identifier, wherein each mobile device can be associated with a unique master identifier. For each of the plurality of click events, the server computer can store the click in a click data record in a database. The server computer can then conduct an analysis for a first mobile device comprising the following steps. In some embodiments, the server computer can conduct the analysis for the plurality of mobile devices.

The server computer can further receive in-app data of an in-app event of a first mobile device. The app data can include a first device identifier and the in-app event may be a first opening of a mobile application by a user or an activity with the mobile application that occurs while the mobile application is in use. The server can then generate hashed versions of the first device identifier associated with the first mobile device. The server computer can store in a first device data record of the database, the first device identifier and the hashed versions of the first device identifier in association with a first master identifier corresponding to the first mobile device and in association with the in-app data of the in-app event. The server computer can then access the first device data record and the click data records to compare the at least one device identifier in click data for at least a portion of the click events with one or more of the hashed versions of the first device identifier associated with the first master identifier.

The server computer can conduct click fraud analysis. The server computer can access the database to identify click data records storing click data including a first campaign identifier associated with a first display campaign from the plurality of display campaigns and determine an amount of the identified click data records to determine a total count of click events associated with the first display campaign. The server computer can then access the database to identify device data records storing the click data stored by the identified click data records, wherein each device data record is associated with a unique master identifier, determine a number of the identified device data records, and obtain a quality score based on the determined number of identified device data records and the total count of click events. In some embodiments, the quality score can be obtained by dividing the determined number of device data records by the total count of click events.

In some embodiments, the server computer can identify whether the quality score is below a threshold and send, to a computing device operated by a campaign buyer associated with the first display campaign, an alert if the quality score is below the threshold. In some cases, the server computer can track the quality score based on one or more categories, the one or more categories including at least one of: a specific country, a media partner, an operating system type, a browser type, and a geographic location.

In some cases, the click data for each of the plurality of click events and the in-app data for the in-app event includes a timestamp. This can enable the server computer to conduct click path analysis. The server computer can access the first device data record to identify the click events related to the first mobile device and determine one or more preceding click events from the identified click events, wherein click data of each of the one or more preceding click events includes a timestamp that occurs earlier than the timestamp included in the in-app data for the in-app event. The server computer can then determine a chronological order of the preceding click events.

In some cases, the server computer may determine a total number of preceding click events and a time period over the preceding click events occur. To determine the time period, the server computer can determine a first click event from the preceding click events with click data including a first timestamp that occurs first out of the preceding click event and a second click event from the preceding click events with click data including a second timestamp that occurs last out of the preceding click events. The server computer can then determine a time period over which the preceding click events occurred by calculating the time difference between the second timestamp and the first timestamp. In some embodiments, the total number of preceding click events and the determine time period may be provided to a computing device of a campaign buyer.

Embodiments of the invention are further directed to a server computer comprising a processor and a computer readable medium coupled to the processor. The computer-readable medium can comprise instructions, that when executed by the processor, can perform any of the methods described herein.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 shows an example flow of data between components according to embodiments of the present invention.

FIG. 2A and FIG. 2B show exemplary click events leading to an in-app event according to embodiments of the present invention.

FIG. 3 shows an exemplary click data record according to embodiments of the present invention.

FIG. 4 shows an exemplary device data record according to embodiments of the present invention.

FIG. 5 shows a flowchart for a method according to embodiments of the present invention.

FIG. 6 shows a flowchart for conducting click fraud analysis according to embodiments of the present invention.

FIG. 7 shows a flowchart for conducting click path analysis according to embodiments of the present invention.

FIG. 8 shows a sample visualization of data related to click fraud analysis according to embodiments of the present invention.

FIG. 9 shows a sample visualization of data related to click path analysis according to embodiments of the present invention.

FIG. 10 shows a sample visualization of data related to click path analysis according to embodiments of the present invention.

FIG. 11 shows sample architecture for data collection and data attribution according to embodiments of the present invention.

FIG. 12 shows user request fulfillment architecture according to embodiments of the present invention.

FIG. 13 shows a block diagram of an example computer system 10 usable with system and methods according to embodiments of the present invention.

### DETAILED DESCRIPTION

Currently, analytics tools only track converting clicks (e.g., the click that occurred directly before an installation of a software application or other event of interest) and do not show the clicks leading up to the converting click. Yet, the full click path, including clicks that occurred prior to a converting click, is more illuminative of consumer behavior than just the converting click alone. As a result, campaign buyers (e.g., advertisers) currently do not have a full window into this area, which can allow them to optimize their ad spend.

Additionally, current analytics tools do not record journey length (e.g., number of clicks in a click path) for a consumer before arriving at an event of interest. Thus, other information, such as the average journey time (e.g. on average, it took 5.4 clicks and 9 days from the first click to conversion) is also not available. Without this information, campaign buyers have a more difficult time deciding how and when to optimize a campaign and to make decisions based on the performance on the campaign.

Embodiments of the present invention provide systems and methods for tracking and analyzing activity on mobile devices. Embodiments can create a data record comprising a “master identifier” that links together a mobile device's activites for each device, despite industry-wide device ID fragmentation, which facilitates advanced click fraud and click path analyses.

### I. Data Flow

A. Click Events and In-app Events

Embodiments track mobile activity by analyzing click events and in-app events that occur during a user's use of a mobile application. A description and examples of click events and in-app events are provided below.

As used herein, a “click event” may occur when a user clicks on a link while utilizing a mobile device. The link may be of any suitable form, such as any combination of text, images, videos, etc. that can be clicked by the user. In some cases, the link may be associated with a display campaign (e.g., advertisement campaign) and clicking the link may trigger the mobile device to open a new web window or page related to the display campaign. Each click event is associated with click data, which is any information related to a corresponding click. For example, click data can include at least one device identifier of the mobile device and a display campaign identifier associated with a click event. In some cases, click data can further include a timestamp associated with the click event.

As used herein, an “in-app event” may be any mobile activity that occurs within a mobile application by a user. The in-app event may include any mobile activity starting from the first opening of a mobile application. Other examples of in-app events include purchases, registrations, subscriptions, level completions, etc. that can occur while the user is utilizing the mobile application. In some cases, in-app events may be associated with device identifiers that can be sent by a software development kit (SDK) packaged within the mobile application. In-app events may also be reffered to as “SDK events.”

In some embodiments, one or more click events may lead to an in-app event. Thus, in some cases, click events can occur before installation of a mobile application, where the click events make up a click path that leads to the first opening of the mobile application. In other cases, click events can occur during use of a mobile application, where the click events make up a click path that leads to an in-app event (e.g., purchases, registrations, etc.) that occurs after the mobile application has been installed.

B. Data Collection

Certain embodiments measure the performance of mobile display campaigns by comparing data related to in-app events (e.g. a download, purchase, subscription, etc.) that is collected through a marketing attribution SDK, against tracking URLs. Tracking URLs can be utilized to track certain elements when a link, such as a mobile banner ad, is clicked on). Through this comparison, a click on a mobile display campaign may be matched to SDK conversion data. In some embodiments, the display campaign may be advertisement campaign.

In one embodiment, any time a user clicks on a link that is part of a display campaign (e.g., marketing campaign), a tracking URL may forward the user to a server where data is collected about that tracking URL. For example, the data may include how many times the display campaign has been clicked and information about the device that was used to activate the tracking URL (e.g., HTTP header information, IP address, device type, etc.). The tracking URL may be a unique URL that is generated for an advertiser as part of a display campaign. When the tracking URL is activated by a click on a link that is part of a campaign, the click may be registered by a collector server to identify the click via an associated device identifier, recall certain settings related to the advertising campaign, and redirect the user to the URL of their final destination. A click event registered with the platform as described above is hereinafter referred to as a “click event.”

Tracking may also be done for in-app events that take place from within mobile applications. In one embodiment, an SDK is downloaded (e.g., packaged within a mobile application), which can send data including device IDs directly from the user's device to the collector server in response to certain in-app events (also referred to herein as “SDK events”). Examples of SDK events may include the first opening of a mobile application, or in-app events like in-app purchases, registrations, level completions, etc. In some cases, advertisement campaign buyers may designate which in-app events they want the SDK to track. The collector server can analyze the data to identify the event via an associated device identifier.

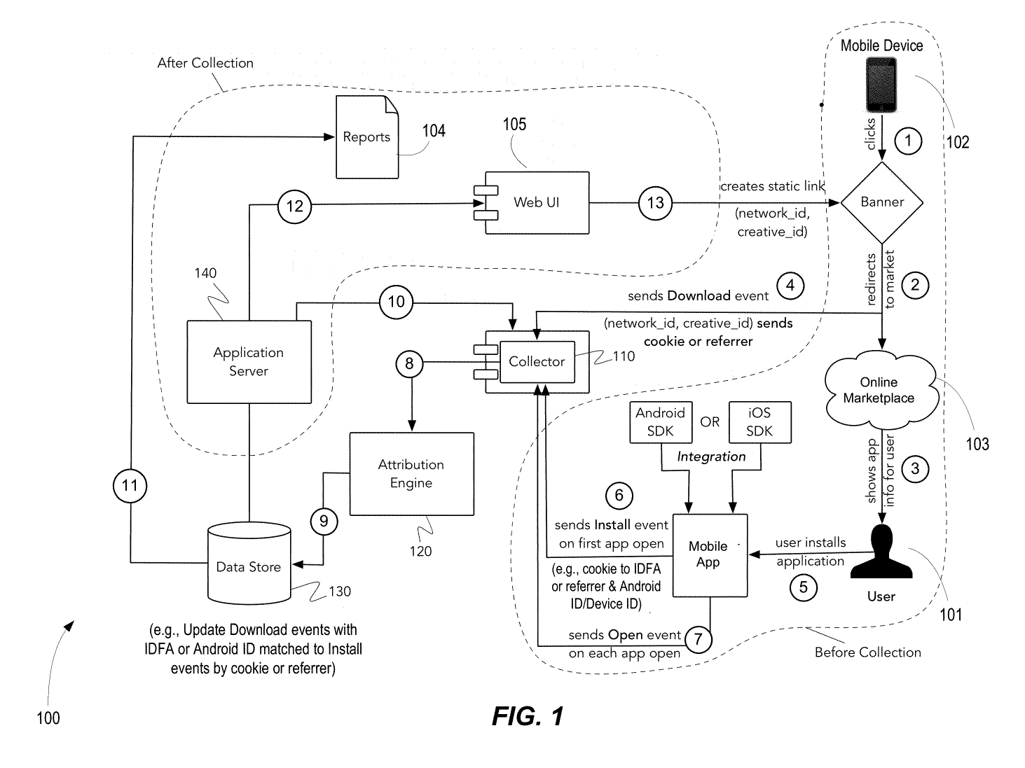

Data may travel across the system of certain embodiments of the present invention as described below with respect to FIG. 1. Some steps in the data flow of FIG. 1 may be shown by circles including a step number and are described herein. In FIG. 1, a user 101 may operate a mobile device 102. In some embodiments, some steps described in FIG. 1 may occur in a different order than described herein, and some steps may occur concurrently.

Mobile device 102 may be any suitable electronic computing device that can be operated by user 101. Mobile device 102 may comprise one or more processors and a memory element, input devices, and output devices operatively coupled to the one or more processors. Mobile device 102 may also comprise an external communications interface for communicating with other entities over a communications network. In some cases, the memory element may store one or more mobile applications.

In some embodiments, mobile device 102 may be hand-held and compact so that it can fit into a pocket (e.g., pocket-sized). Some non-limiting examples of mobile device 102 may include mobile devices (e.g., cellular phones, keychain devices, personal digital assistants (PDAs), pagers, notebooks, laptops, notepads, wearable devices (e.g., smart watches, fitness bands, jewelry, etc.), automobiles with remote communication capabilities, personal computers, and the like.

At step 1, a user 101 may click on a banner using their mobile device 102. The banner may be associated with a display campaign (e.g., advertisement campaign, marketing campaign, etc.). The banner may be of any suitable form and may include any combination of text, images, videos, and other forms of media. The click by user 101 may be a click event, which may activate a tracking URL. When the tracking URL is activated, collector 110 may recall certain settings related to the advertising campaign and redirect the user to the URL of their final destination (e.g., online marketplace 103).

At step 2, the user 101 may be redirected to an online marketplace 103. In some embodiments, online marketplace 103 may be a website or application that can run on mobile device 102. In some cases, online marketplace 103 may be operated by a merchant. Online marketplace 103 may offer downloadable mobile applications and may provide a user interface that user 101 may interact with to browse the mobile applications. User 101 may select a mobile application using the user interface.

At step 3, online marketplace 103 may display information related to the mobile application selected by user 101. For example, the information may include a price for downloading the mobile application, description of features, reviews, screenshots, and any other information that may help user 101 learn about the mobile application. A button on the user interface may also be displayed, which user 101 can activate (e.g., by selecting) to trigger the mobile application to download onto mobile device 102. In some embodiments, the mobile application may be downloaded with a SDK, which may be packaged within the mobile application. The SDK may run with any suitable OS (Operating System) (e.g., Android, iOS, etc.).

At step 4, an indication of a “download event” may be sent to collector 110 from mobile device 102. The “download event” may be communicated in any suitable form (e.g., electronic message, indicator, or electronic message including indicator) to collector 110 to notify that the mobile application has been downloaded to mobile device 102. In some embodiments, a cookie or referrer (e.g., URL, IP address, etc.) may be sent to collector 110.

At step 5, the mobile application may be installed onto mobile device 102. User 101 may now be able to open the mobile application (which may also be known as a customer application) on mobile device 102.

At step 6, an indication of an “install event” may be sent to collector 110 from mobile device 102. The “install event” may be communicated in any suitable form (e.g., electronic message, indicator, or electronic message including indicator) to collector 110 to notify that the mobile application has been installed on mobile device 102. In some embodiments, collector 110 may be notified of the install event when the mobile application is actually installed on mobile device 102. In other embodiments, collector 110 may be notified of the install event upon user 101 opening the mobile application for the first time on mobile device 102.

At step 7, an indication of an “open event” may be sent to collector 110 from mobile device 102. The “open event” may be communicated in any suitable form (e.g., electronic message, indicator, or electronic message including indicator) to collector 110 to notify that the mobile application has been opened for the first time on mobile device 102. As described in step 5, in some embodiments, the open event and install event may be communicated to collector 110 at the same time. In some cases, an open event may be communicated to collector 110 each time user 101 opens the mobile application on mobile device 102 (e.g., every new use session).

After the mobile application is installed and opened for the first time on mobile device 102, a device identifier associated with mobile device 102 may be sent to collector 110. In some embodiments, the device identifier may differ based on the OS running on mobile device 102. For example, if mobile device 102 is running iOS, an IDFA (identifier for advertising) may be sent to collector 110 and if mobile device 102 is running Android, an Android ID or Android Advertising ID may be sent to collector 110. Collector 110 may associate the received device identifier with the received install event, open event, and mobile device 102.

The click event associated with the clicking of the banner by user 101, which activated the tracking URL, may be registered by collector 110. Collector 110 may associate the click event with the received device identifier, as well as other information associated with the device identifier, such as the received install event and open event.

Any future in-app events within the mobile application conducted on mobile device 102 may be sent from mobile device 102 to collector 110. In some embodiments, the built-in SDK on mobile device 102 may send in-app events to collector 110 as they occur. Data related to click events and in-app events may be received and stored by collector 110 in a raw format, as described below.

At step 8, raw data for click data and in-app events stored by collector 110 may be sent to attribution engine 120. Attribution engine 120 may process the raw data received by collector 110. In some embodiments, attribution engine 120 may process and convert the raw data associated with the click events and in-app events to a standard format. This unification process can ensure that only certain data that is essential for further analysis is sent for further processing, which can reduce calculation time and load on the system.

At step 9, attribution engine 120 may send the processed data to data store 130. Data store 130 may comprise one or more external servers including databases for storage and analysis. In some embodiments, the data in data store 130 may be analyzed for click fraud and click categorization/click path analysis, described in more detail below. The data in data store 130 may also be utilized for other purposes, described in the following steps.

At step 10, information from application server 140 may be utilized with data in data store 130 for further processing of the data. In some embodiments, application server 140 may house certain campaign information (e.g., all relevant campaign and partner information related to particular events). Thus, additional information from application server 140 may be utilized to process the data in search of a common device that matches click events and in-app events.

At step 11, data in data store 130 may be utilized for report generation. In some embodiments, tracked information related to mobile device 102 and mobile activity on mobile device 102 may be aggregated into reports 104. In some cases, these reports may be useful for providing summaries of click fraud and click path analysis, as well as other statistics that may be useful to a campaign buyer. The reports may include graphical visualizations of the data for analysis.

At step 12, data processed by application server 140 may be sent to a web user interface 105. After data from data store 130 is sent to application server 140, which may process the data to determine click events, in-app events, click path, and other information associated with mobile device 102, application server 140 may analyze the determined information to select an appropriate display campaign to be displayed by web user interface 105, which may be displayed on mobile device 102. In some cases, the selection of the display campaign may be based on how likely user 101 is to click the display campaign. For example, application server 140 may select a display campaign that is of a specific type (e.g., banner, video, etc.) if analysis shows users are more likely to click the specific type of display campaign.

At step 13, the selected display campaign may be set up to be displayed on mobile device 102. In some embodiments, a static link may be created for the display campaign such that user 101 can click on the display campaign, which may activate a tracking URL.

C. Exemplary Click Events Leading to an In-app Event

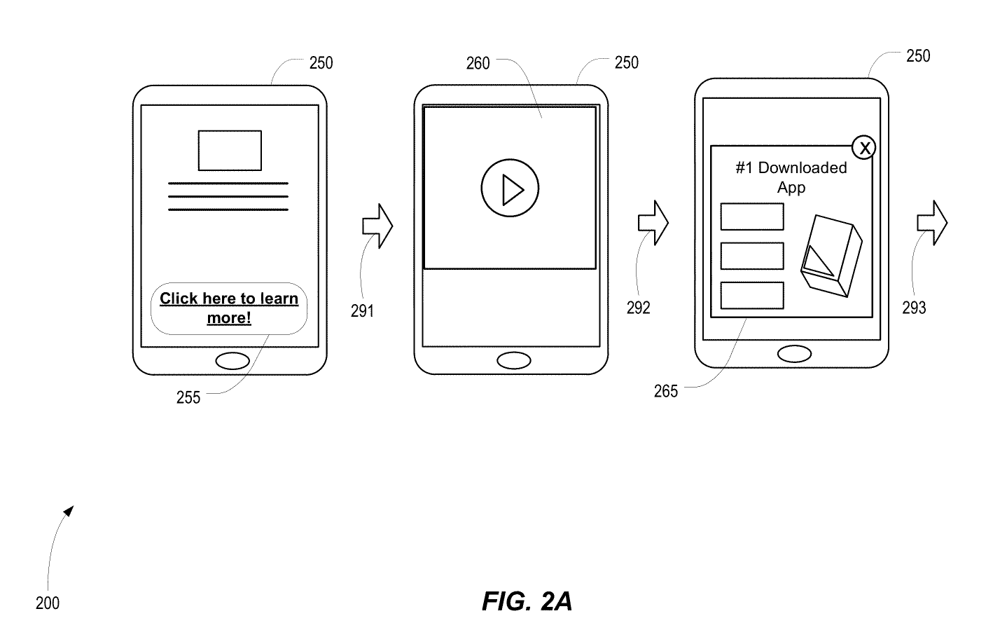

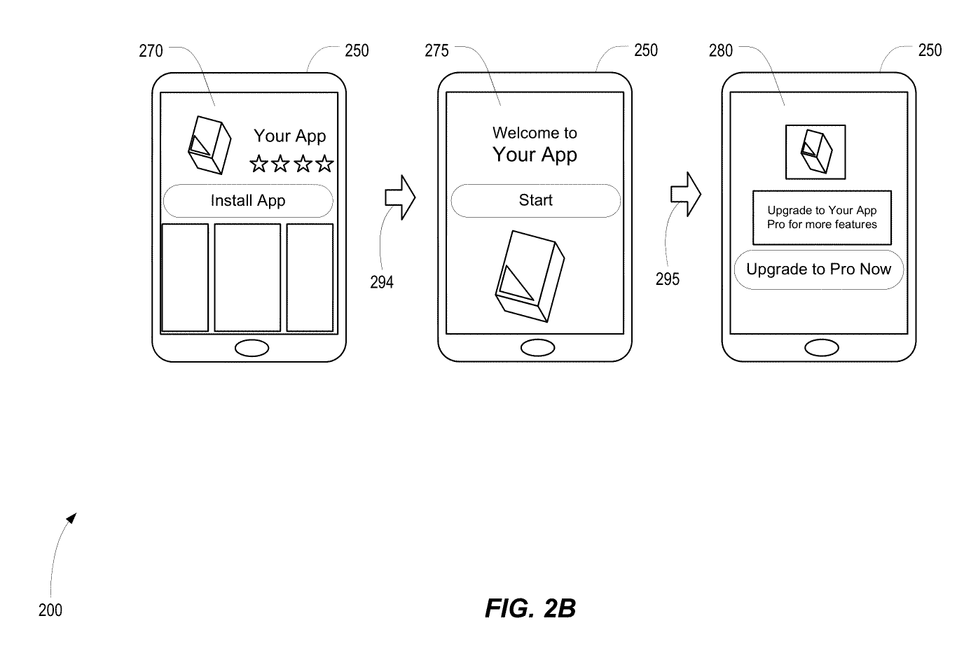

FIG. 2A and FIG. 2B shows user interfaces showing exemplary click events leading to an in-app event according to embodiments of the present invention. A user, such as user 101 in FIG. 1, may operate mobile device 250. In some embodiments, the user may perform a number of click events on mobile device 250 before downloading and installing a mobile application on mobile device 250.

Initially, mobile device 250 may display a first display campaign 255. In some cases, first display campaign 255 may be displayed as a banner including text and a link as part of a web user interface. Upon the user clicking first display campaign 255, mobile device 250 may redirect the user to a new destination (e.g., new web page) at step 291. In some embodiments, mobile device 250 may redirect the user to a blank webpage hosted by a server (e.g., collector), which can allow the server to collect data on the user. For example, the click at step 291 may be a first click associated with a first click event and click data corresponding to the first click event may be sent to the server. In some cases, mobile device 250 may then automatically redirect the user to an online marketplace (e.g., mobile app store) comprising downloadable mobile applications.

After being redirected, mobile device 250 may display a second display campaign 260. In some cases, second display campaign 260 may be a banner that plays a video. Upon the user clicking second display campaign 260, mobile device 250 may redirect the user to a new destination (e.g., new web page) at step 292. In some embodiments, mobile device 250 may redirect the user to a blank webpage hosted by the server, which can allow the server to collect data to collect data on the user. For example, the click at step 292 may be an assisting click associated with a second click event, where the assisting click comes before a converting click. Click data corresponding to the second click event may be sent to the server. In some cases, mobile device 250 may then automatically redirect the user to the online marketplace comprising downloadable mobile applications.

Mobile device 250 may then display a third display campaign 265. In some cases, the third display campaign may be a pop-up advertisement. Upon the user clicking third display campaign 265, mobile device 250 may redirect the user to a new destination at step 293. In some embodiments, mobile device 250 may redirect the user to a blank webpage hosted by the server, which can allow the server to collect data to collect data on the user. For example, the click at step 293 may be the converting click associated with a third click event, where the converting click occurs closest in time to an in-app event. Click data associated with the third click event may be sent to the server. Mobile device 250 may then automatically redirect the user to the online marketplace comprising downloadable mobile applications.

Mobile device 250 may then display a user interface 270 (e.g., hosted by a mobile app store) for downloading the mobile application. In some cases, the user may confirm to download the mobile application by activating (e.g., clicking) a software button (e.g., with text “Install App”) at step 294. In some embodiments, a SDK may be downloaded with the mobile application.

The user may then open the mobile application for the first time, which may be an in-app event. Mobile device 250 may display a user interface 275 that may be a standard first page associated with the mobile application. While an exemplary user interface 275 is shown in FIG. 2B, it is understood that there is no need for a custom landing page for the mobile application. Upon the first opening the mobile application, the SDK may be called, enabling a device identifier may be sent to the server from mobile device 250. In some cases, the SDK may run the moment it is called, which may be before the first page of the mobile application has fully rendered. The server may then generate and store all permutations of the received device identifier, including all hashed versions of the received device identifier.

The server may then determine whether the previous clicks, including the first click, the assisting click, and the converting click, originated from the same mobile device 250 from which the in-app event originated. The server may determine whether the device identifiers associated with the first click, the assisting click, and the converting click match any of the generated permutations of the received device identifier. If so, the server may recognize that the click events originated from the same mobile device 250 and store the click data associated with the first click, the assisting click, and the converting click in association with the in-app data of the in-app event. Further details of this process may be described in other figures herein.

At step 295, the user may utilize the mobile application and then perform another in-app event. In some cases, the in-app event may be an upgrade for the mobile application. Accordingly, mobile device 250 may display a user interface 280 for upgrading the mobile application. This in-app event, including any future in-app events, may be tracked to mobile device 250 by comparing a device identifier associated with the in-app event to the different device identifier versions generated by the server based on the in-app event. An in-app event may include any mobile activity that occurs within the mobile application, such as an in-app purchase, registration, upgrade, etc.

### II. Matching Various Activity to a Single Device

For every click event and SDK event, some embodiments collect as much data as possible at the point of the click. For every click, the device from which the click originates can be profiled through the logging of device identifiers such as: device ID (e.g., a manufacturer ID or an account ID), IP address, any other information in the http header, etc. In the case that these unique identifiers are not available, data related to the click may be forwarded to a third party, which may generate a third party identifier that may be used. Such third party identifiers may be generated after taking into account various characteristics of the click event and/or SDK event.

A. Creation of Data Record with Click Data

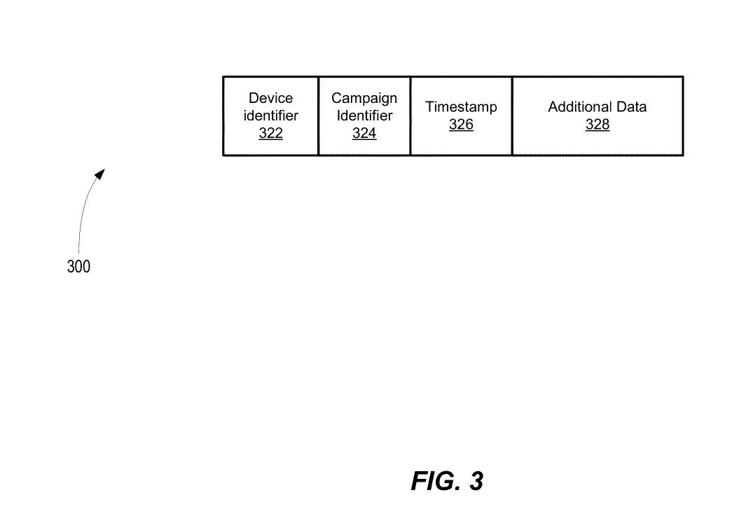

When a click event occurs, click data for the click event may be sent to a server computer. In some embodiments, the click data for the click event may be stored in a click data record in a database, which may store click data, as well as any other information that may be related to the click event. An exemplary click data record is described with respect to FIG. 3.

FIG. 3 illustrates an exemplary click data record 300 according to embodiments of the present invention. Click data record 300 may be generated based upon click data of a click event occurring at a mobile device and stored in a database. The click event may be for a click on a link associated with a display campaign (e.g., advertisement). Click data record 300 includes data elements comprising a device identifier 322, a campaign identifier 324, a timestamp 326, and additional data 328. The elements in click data record 300 described may be stored in any order and in any suitable format.

Device identifier 322 may be an identifier associated with the mobile device from which the click event associated with click data record 300 originated. In some embodiments, device identifier 322 may be passed from a media partner associated with the display campaign that enabled the click event. Depending on the media partner, device identifier 322 may be a hashed version of an unencoded device identifier of the mobile device, using one of many different encoding methods. Hence, while click data record 300 with device identifier 322 may be associated with the mobile device, other click data records with different device identifiers may also be associated with the same mobile device.

Campaign identifier 324 may be an identifier associated with the display campaign that enabled the click event. Campaign identifier 324 may be any suitable length or form and may uniquely identify the display campaign. In some embodiments, campaign identifier 324 may be associated with a URL or part of a URL.

Timestamp 326 may be a value representing a time that the click event occurred. In some embodiments, timestamp 326 may be generated when the click event is registered to the server computer. Timestamp 326 may be any suitable format (e.g., UTC general time format).

Additional data 328 may include any discretionary data related to the click event. In some embodiments, additional data 328 may include data indicating a click event type (e.g., first click, assisting click, contributing click, converting click, etc.), a media partner, and further mobile device information (e.g., OS, browser type, geographic location, IP address, network information, etc.). Data stored in click data record 300 is not limited to the exemplary data elements described.

In some embodiments, the server computer may store one or more click data records in a database. In some embodiments, each data element (e.g., device identifier, campaign identifier, timestamp, etc.) may be stored as separate columns in the database. In other embodiments, one or more data elements may be combined in a column in the database. The database may conduct a query for all data records stored in the database associated with a certain data element. This may enable easy access to click data records corresponding to a group of all click events that are associated by the certain data element (e.g., campaign identifier).

B. Creation of Data Record with Hashed Device IDs

As noted above, device IDs may be collected as part of the tracking solution described in embodiments of the present invention. Device IDs can be received from media partners that serve the display campaign (e.g., advertisement) after links associated with the display campaigns are clicked.

There are many different permutations of the device ID, depending on which media partner it is collected from. For example, a received device identifier may be an IDFA (identifier for advertising) hashed using one of many different encoding methods. Some possible encoding combinations may include, but are not limited to, Md5, SHA1, SHA2, ODIN1, etc. Since a hashed device identifier is one way encrypted, there is no way of reverse engineering the hashed device identifier to link back to an original non-hashed device identifier. The received device identifier may also be an unhashed IDFA, an AdTruth ID, MAC address, or some other type of device identifier.

Due to this fragmentation, it is difficult to utilize device ID data in its raw form to run useful device tracking analysis. Unless a single device's different ID types are linked together, that device cannot be accurately tracked. In other words, analysis using raw data may mistake multiple clicks made by Device A as actually coming from different devices, if different types of device IDs are collected and not standardized.

To solve this problem, embodiments of the present invention may create different permutations of the device IDs after they are received from SDK Events. For example, after receiving a device identifier from a SDK event, a server may generate all permutations of the device identifier, including all hashed versions of the device identifier, as described above. The device identifier from the SDK event and all the different versions of the device identifier may be associated with a single mobile device. Hence, if any click event that is performed by a device that is associated with any of these device identifiers, it can be recognized that the click event originated from the single mobile device.

The device identifier from the SDK event and all versions of the device identifier may be entered into a data record of a database. The data record may be formatted in any suitable manner, as long as the device identifier from the SDK event and all versions of the device identifier are included in the data record. For example, the data record may include an identifier in one column, and an unencoded device ID and all known possible encoding combinations of that device ID in other columns. Other data may also be included in other columns of the data record, such as an operating system, browser type, and geographic location associated with the SDK event.

At every future click event and SDK event on the originating device, the device identifier associated with the future click event and SDK event may be compared to all device identifiers stored in the data record for a match. If a match is found, data corresponding to the future click event and SDK event may be added into the data record.

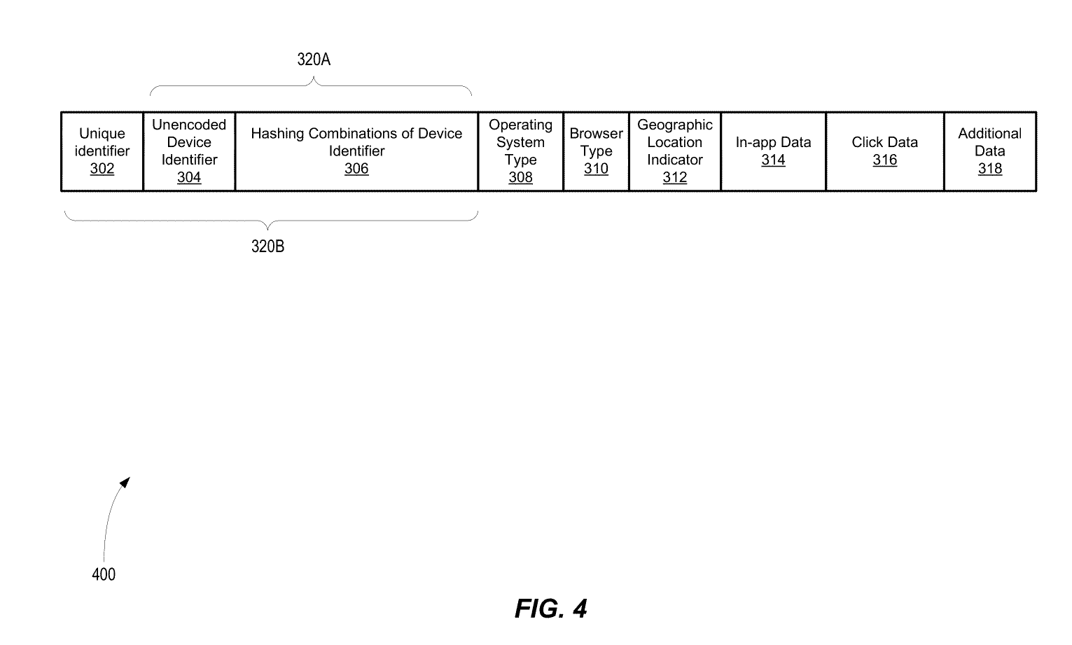

FIG. 4 shows an exemplary device data record 400 according to embodiments of the present invention. FIG. 4 includes data elements comprising a unique identifier 302, an unencoded device identifier 304, hashing combinations of device identifier 306, an operating system type 308, a browser type 310, a geographic location indicator 312, in-app data 314, click data 316, and additional data 318. In some embodiments, device data record 400 may be stored in a database. The information in device data record 400 may be associated with a single mobile device and may be generated when a SDK event occurs within a mobile application running on the mobile device. The elements in device data record 400 described may be stored in any order and in any suitable format.

Unique identifier 302 may be any suitable identifier that can be uniquely identify the data record. Unique identifier 302 may be any suitable form. For example, unique identifier 302 may be a combination of numeric, alphanumeric, and special characters and may be of any length. In some implementations, unique identifier 302 may be generated based on any information included in data record. For example, unique identifier 302 may be a value created using any combination of information, including unencoded device identifier 304 and hashing combinations of device identifier 306, in device data record 400. Unique identifier 302 may be generated by any suitable method.

Device data record 400 may include multiple device identifiers associated with the mobile device. Unencoded device identifier 304 may be a device identifier collected from the SDK event. Unencoded device identifier 304 may be hashed in various encoding methods including, but not limited to, Md5, SHA1, SHA2, ODIN1, etc., which may result in all hashed versions of unencoded device identifier 304 that make up hashing combinations of device identifier 306 in device data record 400.

Device data record 400 may also include other information related to the mobile device. For example, device data record 400 may include operating system type 308, browser type 310, and geographic location indicator 312. Operating system type 308 and browser type 310 may be indicators of the operating system type and browser type running on the mobile device. Geographic location indicator 312 may be geographic information associated with the SDK event. In some embodiments, geographic location indicator 312 may be a set of coordinates or a region. The information included in may be included in operating system type 308, browser type 310, and geographic location indicator 312 may be part of click events and SDK events that are sent from the mobile device.

Device data record 400 may also include in-app data 314. In-app data 314 may also be referred to as SDK data. In-app data 314 may be data associated with the SDK event, which may include the first opening of the mobile application and purchases, registrations, subscriptions, level completions, etc., that occur within the mobile application. For example, in-app data 314 may include a device identifier of the mobile device (e.g., unencoded device identifier 304), a corresponding timestamp, type of event, and any other information related to the SDK event.

Device data record 400 may also include click data 316. Click data 316 may be data associated with one or more click events that originate from the mobile device. Click data 316 may be added to device data record 400 after it is determined that the one or more click events originated from the same mobile device from which the SDK event originated. Click data 316 may include, for each click event, a device identifier of the mobile device, a corresponding timestamp, a campaign identifier corresponding to a clicked link, and any other information related to the click event. In some embodiments, click data 316 may store one or more click data records, such as click data record 300 in FIG. 3, so that data stored in click data 316 may be arranged by click event.

Device data record 400 may further include additional data 318, which may be discretionary data. Additional data 318 may include one or more additional fields that comprise information related to the mobile device that may be useful for analysis (e.g., IP address, network information, etc.). Hence, information in device data record 400 is not limited to the data elements discussed.

Device data record 400 of FIG. 4 shows one exemplary format of data record. However, embodiments are not so limited, as device data record 400 may be formatted in several ways. For example, in some embodiments, each data element described in FIG. 4 (e.g., unique identifier 302, unencoded device identifier 304, hashing combination of device identifier 305, operating system type 308, etc.) may each be stored in a different column of a data record.

In other embodiments, any combination of the data elements may be stored in the same column as subfields. For example, operating system type 308, browser type 310, geographic location indicator 312 may all be stored in one column in a string. The string may include a predetermined terminating character between each data element, indicating where each data element starts and ends. In some embodiments, any suitable data structure, such as a list, table, and array may be utilized to store information in a device data record. For example, unencoded device identifier 304 and hashing combinations of device identifier 306 may be stored in an array in the device data record, where unencoded device identifier 304 may be stored at a predetermined position in the array (e.g., position 0). Such data structures may be convenient to utilize when searching for a match amongst a multitude of stored device identifiers.

C. Master Identifier

In some embodiments, information related to a single mobile device may be identified with a “master identifier” (also known as a Master ID). There are several ways in which the master identifier may be characterized. Some examples are described with reference to FIG. 3.

In some cases, the master identifier may be an identifier that can be utilized to identify a data record, such as unique identifier 302. As described above, unique identifier 302 may be a unique value which, in some embodiments, may be generated using unencoded device identifier 304 and hashing combinations of device identifier 306. In other cases, the master identifier may be an object including multiple data elements as shown by 320A, which include unencoded device identifier 304 and hashing combinations of device identifier 306. Another example is shown by 320B, which includes unique identifier 302, unencoded device identifier 304, and hashing combinations of device identifier 306. In any case, the master identifier may be stored in association with all device identifiers associated with a mobile device.

The master identifier may be generated and associated to the single mobile device, such that the master identifier may be consistent across different events originating from the single mobile device. The result is that the device can be represented in a database by a single identifier, despite the many formats that the identification may initially be received. The master identifier may be stored in a data record in association with further information, as shown in exemplary device data record 400 of FIG. 4.

For further understanding, an exemplary use of a master identifier is described. A device ID in the form of a hashed IDFA may be received from a first click event on Media Partner A's network, a device ID in the form of an unhashed/unencoded IDFA may be received from a second click event on Media Partner B's network, and an unhashed/unencoded device ID may be received from an SDK event.

For the tracked SDK event, all known permutations of the unhashed/unencoded device ID that is collected with the SDK event may be generated. The permutations may include hashed versions of the unhashed/unencoded device ID. These generated device IDs may be aggregated into a single object, which, in some embodiments, may be the Master ID for the device that triggered the SDK event. In other words, the Master ID may be an array of different encoded formats of the unhashed/unencoded device ID that is collected for each tracked SDK event.

Then, an analysis can be run that compares the device identifiers associated with the tracked click events (in this example, the hashed IDFA from the first click event and the unhashed/unencoded IDFA from the second click event) with the device IDs store in association with the Master ID. If a matching pair of device identifiers is found, then it can be determined that the same device triggered the click event and the SDK event associated with the Master ID. For example, if the Master ID contains an encoded device ID that matches the hashed IDFA of the first click event, this shows that the same device triggered the SDK and the first click event. Further detail on modeling applications that make use of the Master ID are described below.

In some embodiments, certain filters may be utilized to narrow the comparison analysis by certain subsets of data. For example, only Master IDs that are associated with certain categories, such as an operating system, browser type, or geographic location indicator, may be selected for comparison. This can reduce the amount of data to be compared, which can save computing resources.

D. Method

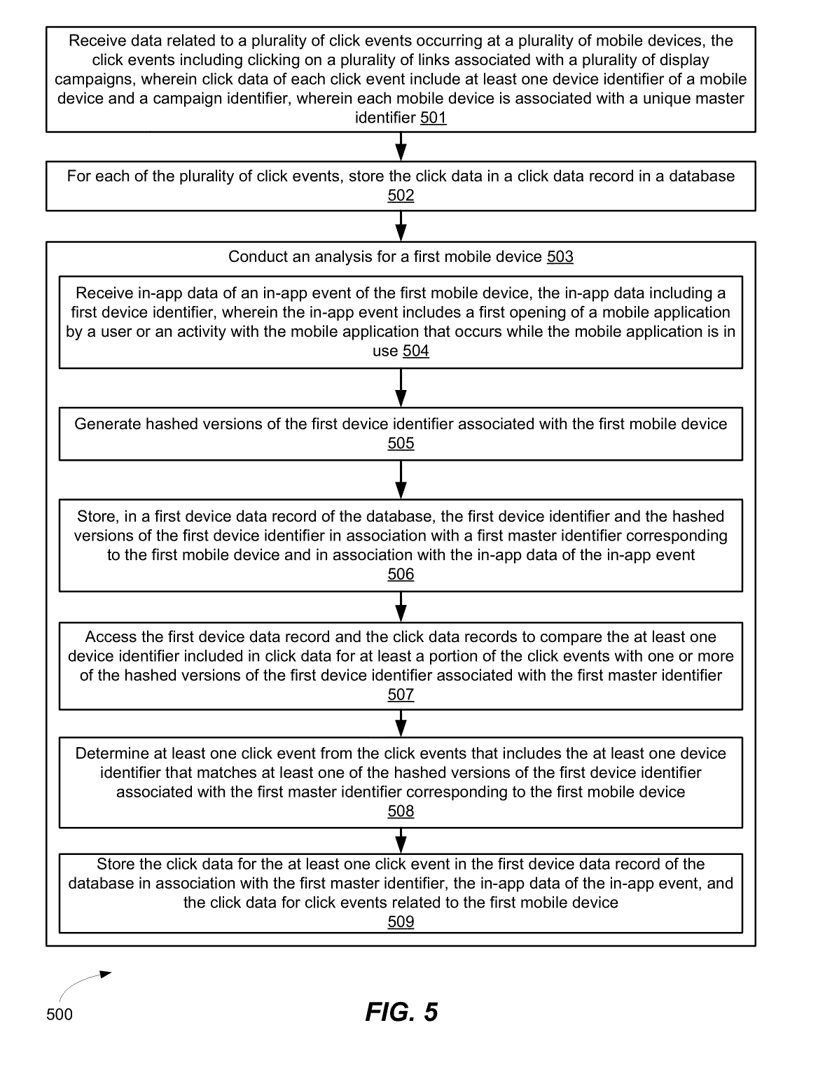

The data record and master identifier as described above may be utilized to match certain mobile activity to a single device. FIG. 5 shows a flowchart 500 for an exemplary method according to embodiments of the present invention. The method may be performed by a server computer, which may track mobile activity associated with one or more mobile devices.

At step 501, the server computer may receive data related to a plurality of click events occurring at a plurality of mobile devices. The total number of click events in the plurality of click events may be any suitable number of click events that the server computer may be capable of receiving. The click events may include clicking on a plurality of links associated with a plurality of display campaigns, wherein click data of each click event may include at least one device identifier of a mobile device and a campaign identifier. The campaign identifier may be any suitable indicator that uniquely identifies the first display campaign that enabled the click events.

Each mobile device may be associated with a unique master identifier. In some embodiments, different device identifiers included in click data for the click events may be associated with a single mobile device. Typically, device identifiers in different forms, such as one device identifier hashed using one encoding method and another device identifier using another encoding method, cannot be tracked to the same mobile device. To solve this issue, each mobile device may be associated with a unique master identifier stored in association with all permutations of device identifiers for a mobile device, which may enable tracking of mobile activity to the mobile device.

At step 502, the server computer may, for each of the plurality of click events, store the click data in a click data record in a database. The click data records may be of any suitable format (e.g., click data record 300 of FIG. 3). In some embodiments, the click data records for the plurality of click events may be stored in a click data database. Hence, the click events may easily be grouped by a certain category (e.g., by campaign identifier).

At step 503, the server computer may conduct an analysis for a first mobile device. In some embodiments, the server computer may further conduct the analysis for the plurality of mobile devices. In some cases, the analysis may include the following steps.

At step 504, the server computer may receive in-app data of an in-app event (SDK data of a SDK event) of the first mobile device, wherein the in-app data may include a first device identifier. The in-app event may include a first opening of a mobile application by a user or an activity that occurs while the mobile application is in use. For example, the in-app event may also be a purchase, upgrade, registration, or other event that is conducted within the mobile application. The in-app event may trigger the in-app data including the first device identifier to be sent to the server computer. The first device identifier may be an unhashed device identifier. In some embodiments, the first device identifier may be encrypted using a private key (e.g., utilizing AES encryption) when stored at the server computer to improve security.

At step 505, the server computer may generate hashed versions of the first device identifier associated with the first mobile device. In some embodiments, the server computer may generate all hashed versions of the first device identifier, such that any permutation of a device identifier associated with the first mobile device may be known by the server computer. The first device identifier may be hashed in various encoding methods including, but not limited to, Md5, SHA1, SHA2, ODIN1, etc. Accordingly, any click event and in-app event corresponding to the first mobile device may be tracked to the first mobile device since the server computer can have knowledge of all permutations of the first device identifier that may be sent with the click data and in-app data.

At step 506, the server computer may store, in a first device data record of a database, the first device identifier and the hashed versions of the first device identifier in association with a first master identifier corresponding to the first mobile device and in association with the in-app data of the in-app event. Any information stored in the data record associated with the first master device identifier may correspond to the first mobile device. The first device data record may be of any suitable format (e.g., device data record 400 of FIG. 4). In some embodiments, the first master identifier may be a unique identifier of any suitable form that uniquely identifies the data record in the database. In other embodiments, the first device identifier and the hashed versions of the first device identifier may be combined into a single object (e.g., array) to be considered first master device identifier. In any case, the master device identifier may be stored in association with the first device identifier and the hashed versions of the first device identifier.

At step 507, the server computer may access the first device data record and the click data records to compare the at least one device identifier included in click data for at least a portion of the click events with one or more of the hashed versions of the first device identifier associated with the first master identifier. In some embodiments, the click data records may be stored separately from device data records in the database.

The server computer may access the click data records and may determine a device identifier stored in each click data record. In some embodiments, the server computer may narrow the analysis (e.g., by OS type, browser, etc.) to a portion of the click data records and thus may then determine a device identifier stored in each click data record of the portion of the click data records. The server computer may also access the first device data record, which may comprise the first master identifier stored in association with one or more hashed versions of the first device identifier. The server computer may then compare each device identifier from the click data records with the hashed device identifiers stored in the first device data record.

In some embodiments, the server computer may not compare device identifiers from the click data records with all hashed device identifiers stored in the first data record. For example, once a match between a device identifier from a click data record and a device identifier stored in the first device data record is found, the server computer may end the comparison process for that particular click data record and then move on to another click data record, if exists. This can save computing resources and time.

At step 508, the server computer may determine at least one click event from the click events that includes the at least one device identifier that matches at least one of the hashed versions of the first device identifier associated with the first master identifier corresponding to the first mobile device. Accordingly, if one or more click events correspond to a device identifier that is the same as any of the hashed versions of the first device identifier associated with the first master identifier, this can indicate to the server computer that the one or more click events originated from the same mobile device at which the in-app event of step 504 occurred.

At step 509, the server computer may store the click data for the at least one click event in the first device data record of the database in association with the first master device identifier, the in-app data of the in-app event, and the click data for click events related to the first mobile device. Hence, after determining the at least one click event and in-app event are associated with the same first mobile device, any information related to the mobile activity of the first mobile device may be stored in the first device data record in association with the first master device identifier.

The in-app data of the in-app event may include a timestamp, event type (e.g., open event, etc.), device identifier (e.g., unhashed device identifier), and any other information related to the in-app event. The click data for click events may include a timestamp, device identifier, and any other information related to click events corresponding to the first mobile device. In some embodiments, the click data stored in the first device data record may include one or more click data records (e.g., click data record 300 of FIG. 3) corresponding to click events related to the first mobile device.

### III. Modeling Applications

The ability of embodiments of the present invention to aggregate disparate device IDs and link them to a single device allows for new and extended analyses of data collected related to display campaigns (e.g., advertising campaigns). This is due to the newly-enabled ability to track mobile activity to a single device, despite the fragmented IDs associated with it. Analyses that are made possible or that can be improved upon due to this capability include, but are not limited to, click fraud and click path modeling analyses.

A. Click Fraud Analysis

Click fraud occurs when a person, automated script, or computer program imitates a legitimate user of a web browser/application clicking on a display campaign, for the purpose of generating a charge per click without having actual interest in the target of the campaign's link. While it would be desirable for campaign buyers to identify click fraud, there is currently little that can be done to distinguish between legitimate mobile traffic and fraudulent clicks. This is because fraud analysis generally only tracks the total number of click events over a time period, which is relatively ineffective in identifying fraudulent clicks due to fragmented device IDs associated with click events. This can cause many duplicate clicks events to be missed because it appears as though many of the click events are associated with device identifiers and originated from different devices.

Embodiments of the present invention may conduct click fraud analysis by analyzing the frequency of device identifiers associated with a master identifier during click events, and from this information, identifying potential fraud. In some embodiments, potential fraud may be detected by identifying duplicates (e.g., multiple click events for a display campaign originating from a single device) and high frequency events (e.g., more clicks from the same device than would normally occur within a small time window).

Embodiments of the present invention enable duplicates and high frequency events to be identified with relative precision. This is because all possible device identifiers associated with a single device may be stored in a data record, enabling any clicks by the device associated with the data record to be tracked as originating from a single device. This can overcome the issue of not being able to accurately track mobile activity, even if there is a lack of an industry standard regarding device ID types by various campaign partners (e.g., media partners) issuing display campaigns.

This allows for analysis to be performed quickly, uncovering the performance of different kinds of campaigns (e.g., quality of traffic, etc.). The data can further be examined by other factors, such as by country, media partner, campaign, etc. to obtain different views of the quality of traffic and identify any issues with different media partners. Certain embodiments of the present invention employ a uniqueness algorithm in analyzing click fraud, which is described in more detail below.

1. Method

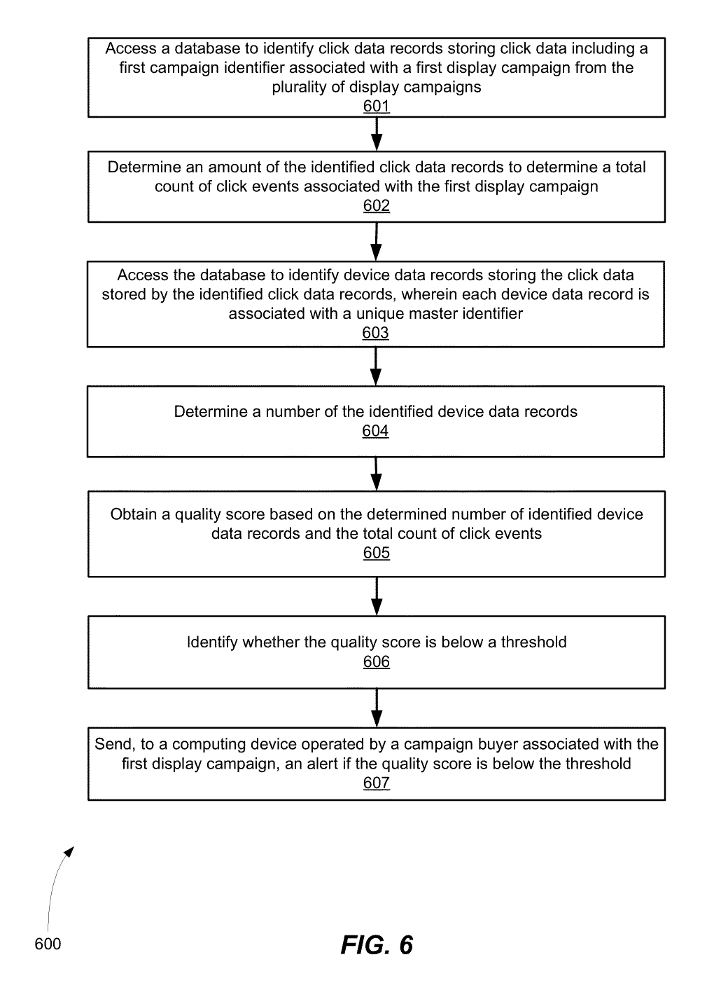

FIG. 6 shows a flowchart 600 of a method for conducting click fraud analysis according to embodiments of the present invention. The method may be conducted by a server computer, which may have access to a database comprising click data records and device data records.

At step 601, the server computer access the database to identify click data records storing click data including a first campaign identifier associated with a first display campaign from the plurality of display campaigns. In some embodiments, the database may comprise all click data arranged by click event, stored by click data records. Since each click data record may store a campaign identifier in a column (e.g., field), the server computer may query the database for all click data records associated with the first campaign identifier in order to identify click data records storing click data including a first campaign identifier. This can identify to the server computer all click events related to the first display campaign.

At step 602, the server computer may determine an amount of the identified click data records to determine a total count of click events associated with the first display campaign. The server computer may determine the amount by simply counting the number of identified click data records from step 601. One way to do this may be to determine the length of a list of the identified click data records.

At step 603, the server computer may access the database to identify device data records storing the click data stored by the identified click data records, wherein each device data record is associated with a unique master identifier. Each click data record may store a device identifier associated with a mobile device from which a click event originated. Each device data record may store a unique master identifier stored in association with all hashed versions of a device identifier for a mobile device, such that each device data record may be correlated to a unique mobile device.

The server computer may then compare each device identifier in the identified click data record to the hashed versions of a device identifier stored in each device data record. If any match is found between a device identifier of a click data record and a device data record, the server computer may recognize that the device data record stores click data of the click data record. In some cases, a device data record may have more than one device identifiers that match device identifiers in click data records, which may indicate that multiple click events originated from the same mobile device.

At step 604, the server computer may determine a number of the identified device data records. The server computer may determine the number by simply counting the number of identified device data records from step 603. One way to do this may be to determine the length of a list of the identified click data records.

At step 605, the server computer may obtain a quality score based on the determined number of identified device data records and the total count of click events. The quality score may provide an indication of whether the click traffic associated with the first campaign identifier originated from unique devices. In some embodiments, a higher quality score may indicate more unique click traffic (e.g., less duplicates) and a perfect quality score may be a value of 1. An exemplary quality score algorithm is described in further detail below in section “Quality Score,” wherein the quality score can be obtained by dividing the determined number of device data records by the total count of click events.

While the embodiments described above describe conducting click fraud analysis for all click events that are associated with the first campaign identifier, embodiments are not so limited. For example, in some embodiments, click fraud analysis may be conducted on click events that occur over a plurality of time periods. For example, the server computer may access the database to identify click data records storing the first campaign identifier and a timestamp within a certain defined time period. Then, the server computer may perform steps 602 to 607 based on the identified click data records.

Additionally, in some embodiments, the server computer may track the quality score based on one or more categories. The one or more categories may include at least one of a specific country, media partner, an operating system type, a browser type, and a geographic location, and other suitable characteristics. The server computer may first determine the one or more categories and then query the database to identify all click data records associated with the one or more categories. Then, the server computer may perform steps 602 to 607 based on the identified click data records.

At step 606, the server computer may identify whether the quality score is below a threshold. In some embodiments, the threshold may be a value set by the server computer or communicated to the server computer from a campaign buyer associated with the first display campaign. Since the quality score may correlate with uniqueness of click traffic, a lower quality score may not be desirable for the campaign buyer. In some cases, the lower quality score may indicate potential click fraud, which the campaign buyer may be interested in preventing and thus may desire to analyze the click events in further detail.

For example, the campaign buyer may want to analyze the number of duplicate clicks associated with a single mobile device. After identifying device data records at step 603, the click data records may be grouped by association with the device data records. In other words, any click data record with click data including a device identifier that matches a device identifier stored at a device data record can be associated with the device data record. The number of click data records associated with a device data record may indicate the number of duplicate clicks that occur at a single mobile device.

At step 607, the server computer may send, to a computing device operated by a campaign buyer associated with the first display campaign, an alert if the quality score is below the threshold. The alert may be an electronic message including any relevant information, such as the quality score, the click events identified associated with the first campaign identifier, the number of click events originating from unique devices, the number of click events associated with each device, duplicate click events, high frequency click events, and any other suitable information.

If the quality score is tracked over a time period and/or based on one or more categories as described above, the server computer may identify whether each quality score tracked for each time period and/or one or more categories is below the threshold at step 607. Subsequently, the server computer may send an alert to the computing device operated by a campaign buyer associated with the first display campaign for any of the quality scores determined to be below the threshold. The alert may include any relevant information as described above, as well as quality scores for each time period and/or one or more categories and descriptions of the time periods and the one or more categories.

In some embodiments, the campaign buyer associated with the first display campaign may receive the alert and decide to analyze the click events in further detail (e.g., over other time periods and categories) to further investigate click fraud. In some cases, the campaign buyer may also modify their media spend based on unique click traffic determined by the click fraud analysis

2. Quality Score

Embodiments may calculate a value (hereinafter referred to as a “quality score”) to be assigned to the clicks that are received in association with a mobile display campaign during a certain time period. The quality score may be correlated with the number of unique devices that perform click events. Since device data records comprising a master identifier stored in association with hashed versions of a device identifier are each associated with a unique mobile device, such device data records may be utilized to determine the number of unique devices associated with click events. This number can represent a probable legitimacy of each click (i.e. the likelihood that it represented a user's actual interest in the target of the ad's link, as opposed to being a part of a fraudulent campaign to generate a charge for the click).

In some embodiments, the quality score may be calculated with an exemplary formula as shown below.

Quality Score=(Total unique devices associated with click events)/(Total click events)

In the above formula, unique traffic (represented by the number of unique users in a data set) is divided by the overall traffic (represented by the number of events counted in the data set). In some embodiments, the data set may include data for events that may take place in a particular time frame, which can be identified by accessing a database to identify click data records storing a timestamp that falls within the time frame. A perfect quality score in this example, then, may be 1.

In other words, a series of many clicks on a display campaign that originate from the same device during a short period of time may indicate that click traffic did not originate from unique mobile devices, and therefore may contribute to a lower quality score. The lower quality score can reflect a likely purpose to generate a charge per click rather than being indicative of actual interest in the target of the ad's link. Since device identifiers associated with the click events can be tracked to a single mobile device based on a device data record comprising the master identifier stored in association with all device identifiers associated with the mobile device, the quality score may be calculated effectively, even if the click events may be associated with different hashes of the same device identifier that cannot be traced back to a single unencoded device identifier.

Other types of click events may have other effects on the quality score as well. For example, some clicks may appear to be fraudulent in that they originate from a device associated with the same master identifier in a short period of time, but actually represent legitimate activities, such as when a user switches data connections, or fails and retries an installation. In such scenarios where click events may include duplicate click events originating from the same mobile device, but are not likely to represent overtly fraudulent activity, the quality score may reflect this. For example, the quality score may not be lowered as much as it would for fraudulent activity. Clicks that appear to come from legitimate traffic (e.g., by those having actual interest in the target of the display campaign's link) may originate from unique devices and therefore can increase the quality score of the click traffic analyzed.

3. Data Output

A visualization program output may show a user of a visualization program (e.g., a campaign buyer), in graphic terms, the health, and trends of a display campaign. It may also alert the user if certain conditions (e.g., thresholds), as defined either by default or by the user of the visualization program, are reached (e.g. a 10% drop in traffic quality occurs), which may indicate fraudulent activity. Visualizations may not be limited to quality score alone. More detailed reports may be produced for users as well.

In one exemplary visualization, the quality score(s) generated as described above may be organized into a format that can be input into a visualization program. For example, the quality score for a display campaign may be plotted against time in a graph, which may indicate a critical time at which the quality score drops below a threshold. In some cases, the quality score may be plotted in a graph based on one more categories (e.g., by a country, media partner, an operating system type, a browser type, and a geographic location), which may indicate a certain subgroup of click events that may have a quality score below a threshold.

In other exemplary visualizations, an association between clicks and devices from which the clicks originate may be input into the visualization program. For example, the visualization may include a graph that plots click events that occur within a time period in association with devices from which the click events originated. This may indicate that a significant number of clicks (e.g., 30% of clicks that occurred during a one minute time period) associated with a display campaign originated from a single device. In another example, the visualization may include a graph that plots in-app events that occur within a time period in association with devices from which the in-app events originated. This may indicate that a significant number of in-app events (e.g., 50% of the in-app events that occurred during a 30 second time period) originated from a single device.

These exemplary visualizations can help a campaign buyer identify potential click fraud based on being able to decipher duplicative click events and in-app events originating from a single device. It is understood that any suitable visualizations may be generated based on click fraud analysis results.

4. Click Fraud Analysis Uses

Click fraud analysis results may be utilized as evidence that can be utilized to claim suspicious activity by a certain display campaign source (e.g., media source). For example, once the click fraud analysis is run, any suspicious activity (e.g., indicated by a high fraud score, or low quality score) by a certain media source may be highlighted. Communication may be sent to the media source flagging dates, times, device types, campaigns, countries, and other categories under which the suspicious activity was detected. The media source may then either offer a refund to the advertiser or contest the analysis. If the analysis is contested, log data may be provided related to the impacted devices for further review. For example, the log data may include additional detailed analysis of click events associated with the impacted devices based on specific time periods and categories. The media source may then either offer a refund or provide an explanation of why suspicious activity was detected.

In an exemplary case, when a campaign partner (e.g., media partner) sends out a bill for delivering x clicks and y installs, a campaign buyer may use click fraud analysis data captured and visualized to produce evidence that some of the billed activity was suspicious and therefore should not be charged. For example, the visualization of click fraud analysis results may indicate that 30% of the clicks originated from the same device within a 1 minute time period, and 50% of the installs were duplicates that occurred in 30 seconds. Using this data, the campaign buyer may be able to back up claims of fraudulent traffic, since a significant portion of clicks originated from the same device during a short period of time. This may allow the campaign buyer to get refunds on their display campaigns and/or convince a campaign partner to further investigate the suspicious activity.

Such fraud detection can become even more important as time passes, since more fragmentation may occur as more device ID types are passed on. As this happens, embodiments may be expanded such that new device ID types may be added to the data record associated with a master identifier for each device, so that events associated with the new device IDs may be tracked to a specific device. This enables click fraud analysis to be conducted by the methods described herein.

B. Click Path Analysis

Embodiments of the present invention may conduct “click path analysis” by assigning click events to data records associated with master identifiers and categorizing the click events chronologically based on a timestamp associated with each click event. The timestamp may mark the moment of registration of a click event or SDK event, e.g. in UTC general time format. Timestamps may be collected, by querying a server to determine the exact time that each click event and SDK event was received by the server. In some cases, timestamps may be stored as a database entry in the data record storing each click event and SDK event (e.g., as part of click data an in-app data).

Event matching is primarily limited to methods of “last click attribution,” which focus solely on the converting click—that is, the click that directly led to the event of interest (e.g. a purchase, download, install, etc.). This is limiting for campaign buyers, as the converting click only provides a small window of view into consumer behavior, and thus does not allow for optimized campaign spending. For example, an advertisement campaign buyer may not recognize the fact that a single media partner's advertisement was clicked on prior to the converting click 75% of the time, since the buyer only has visibility into analyses surrounding the converting click itself Therefore, the buyer would not know that it may be advantageous to continue allotting money in the budget for the media partner associated with the advertisement that was clicked on prior to the converting click 75% of the time.

Embodiments of the present invention solve this issue by enabling a method to provide a view of a full click path leading to a converting click.

1. Method

With the ability to solve the device ID fragmentation problem, clicks that occur before the converting click can be identified as originating from a unique device (and user), and that entire history of clicks (the “click path”) can be utilized by campaign buyers to optimize their campaign spending strategy. Certain embodiments of the present invention may perform click path analysis as described below.

The following is an example scenario of a click path analysis that could be achieved with certain embodiments. Over the course of three weeks, a user may click on eight different links that are all part of a certain display campaign (e.g. banner ads from various advertising networks and links embedded in marketing emails, also served by various advertising networks) on their mobile device. The user may also download and open a mobile application that has a marketing attribution SDK packaged with it, which is configured to track SDK events as part of that display campaign. By matching the SDK event for the mobile application installation with the eight click events (i.e. the eight clicks on the advertising links) using a device data record storing a master identifier associated with hashed device identifiers of the mobile device, certain embodiments of the present invention can reveal the full user journey across three weeks/eight click events. This is in contrast to previous analyses, where only the click event immediately preceding the SDK event (converting click) could be matched to the SDK event.

Device data records associated with master identifiers can be created from SDK events in a data set (e.g. the mobile traffic during a weeklong period) as described above. After the data records are created, the device identifiers stored in the data records may be compared to device identifiers associated with the click events from a data set. Multiple click events that match device IDs within a data record associated with a master identifier represent a data set (a “user journey”) that indicates the traffic footprint of the unique device associated with the master identifier. Since each click event may have a timestamp registered at the point of click, a chronological order of the clicks can be constructed, even going back prior to the click event (converting click) that directly preceded the SDK event.

For each group of click events that are matched to an attributed SDK event, the click events may be categorized in terms of chronology in comparison to the attributed SDK event. This is possible because every click event has its own timestamp associated with it. One categorization scheme that could be used is as follows:
Converting Click: the click event that occurs closest in time to the SDK event is the “Converting Click.”
Assisting Click: if the SDK event has two or more click events associated with it, the click event before the Converting Click is the “Assisting Click.”
First Click: if the SDK event has three or more click events associated with it, the one that occurred first is the “First Click.”
Contributing Clicks: if the SDK event has four or more click events associated with it, all click events between the First Click and Assisting Click are “Contributing Clicks.”

A click path can be identified for each attributed “install event” that corresponds to the first opening of a mobile application. For each unique user, as local settings of a mobile device are generally changed after the install event, this install event may be sent once in the lifetime of the mobile application. The click path may be stored at a predefined location for further analysis through a graphic user interface.

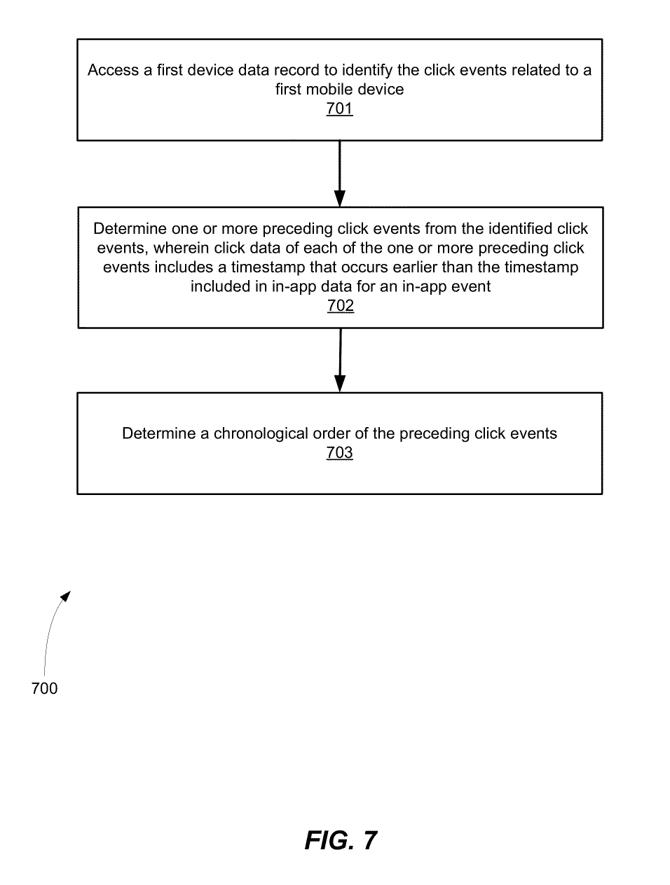

FIG. 7 shows a flowchart 700 of an exemplary method for conducting click path analysis according to embodiments of the present invention. The method may be performed by a server computer.

At step 701, the server computer my access the first device data record to identify the click events related to a first mobile device. The first device data record may store click data for click events associated with the first mobile device (e.g., in a column “click data” as shown in FIG. 4). The server computer may retrieve click data for the stored click events, which may be stored in click data records. The first device data record may also include in-app data for an in-app event that occurred at the first mobile device.

At step 702, the server computer may determine one or more preceding click events from the identified click events, wherein click data of each of the one or more preceding click events includes a timestamp that occurs earlier than the timestamp included in in-app data for an in-app event. Click data for each identified click event may include a timestamp (e.g., in a column “timestamp” as shown in FIG. 3) corresponding to a time that the click event occurred). Timestamps may mark the moment of registration of each click event and in-app event, e.g. in UTC general time format. Timestamps may be collected, by querying a server to determine the exact time that each click event and in-app event was received by the server.

The server computer may compare the timestamp associated with the in-app event with the timestamps associated with the identified click events. Any of the identified click events that have a timestamp that occurs earlier than the timestamp associated with the in-app event may be a preceding click event. The preceding click events may be one or more clicks that lead to the in-app event.

At step 703, the server computer may determine a chronological order of the preceding click events. The server computer may compare the timestamps associated with the determined preceding click events from step 702 and order them by time of occurrence. The ordered preceding click events may make up the click path leading to the in-app event. In some embodiments, the in-app event may be the first opening of a mobile application on the mobile device and the preceding click events may be one or more click events including clicks on links for display campaigns. The converting click event (also known as a conversion event) may be the final preceding click event before the in-app event, and may enable a download of the mobile application (See FIG. 2A and FIG. 2B).

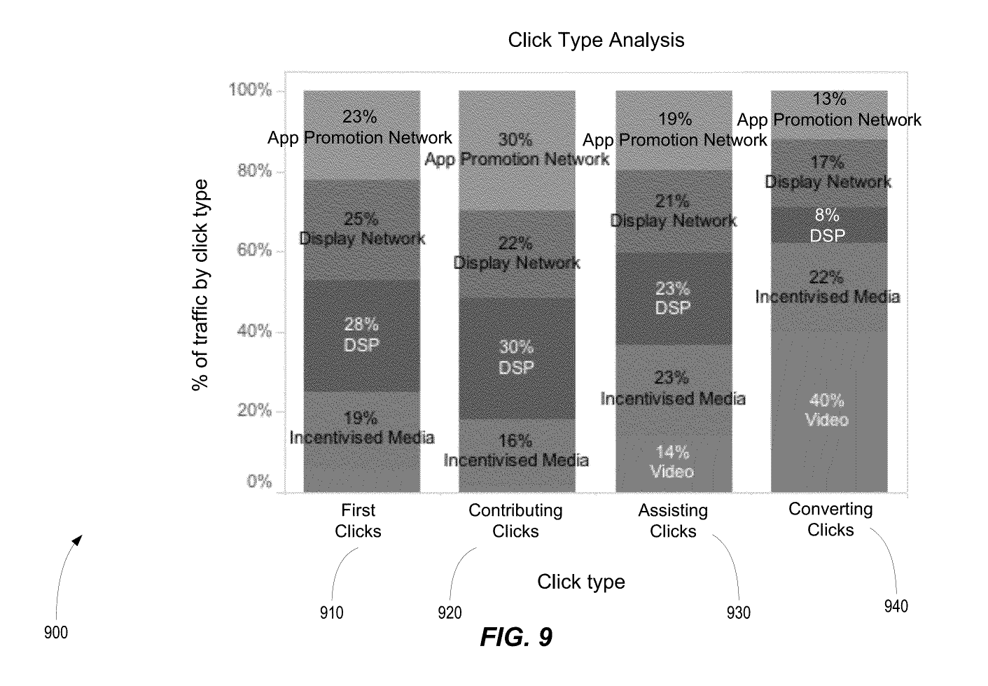

In some embodiments, the server computer may categorize the preceding click events based on one or more categories. In some embodiments, the preceding click events may be categorized into click types, including converting click, assisting clicks, first click, and contributing clicks as described above. In other embodiments, click event data may be grouped according to various click event characteristics, for example by publisher, media sources, networks, etc. to reveal further insights for campaign buyers, e.g. percentage of media types that occur on the different click types (see FIG. 9 for an exemplary visual output). This allows for powerful analytics to analyze the different effects amongst different media types, and to attribute the value of a conversion event to various media types.

The server computer may also determine the number of the preceding click events and a time period over which the preceding click events occurred. The server computer may determine the number of the preceding click events by counting the number of identified preceding click events from step 702. One way to do this may be to determine the length of a list including the data records associated with the identified preceding click events.

The server computer may determine the time period over which the preceding click events occurred based on the timestamps associated with the preceding click events. For example, the server computer may determine a first click event from the preceding click events with click data including a first timestamp that occurs first out of the preceding click events and a second click event from the preceding click events with click data including a second timestamp that occurs last out of the preceding click events. The second click event may also be known as a converting click. The server computer may then determine a time period over which the preceding event occurred by calculating the time difference between the second timestamp and the first timestamp. This can enable determination of the length (number of clicks) and conversion time (time between first click and converting click) associated with a click path.

In some embodiments, the server computer may provide the determined length and conversion time associated with the click path to a computing device of a campaign buyer. The campaign buyer may utilize the information for various visualizations to determine how to effectively allocate media spend for display campaigns. In some cases, click path data associated with a plurality of mobile devices may be aggregated for analysis.

Again, SDK events are typically only attributed to the last click (converting click), whereas the click path analysis carried out by embodiments of the present invention provides a secondary layer of visibility via clicks occurring prior to the converting click, thereby providing insight into the complete user journey. Embodiments of the present invention can provide specific information about the click path taken before the occurrence of the in-app event that typically would not be possible to determine.

2. Data Output

In some embodiments, the click path as generated as described above may be organized into a format that can be input into a visualization program. The visualization program output may show a user of the visualization program (e.g., a campaign buyer), in graphic terms, click events in click path, journey length, click types categorized by media types, conversion time, and any other information that may be determine from a click path. It is understood that any suitable visualizations may be generated based on click path analysis results.

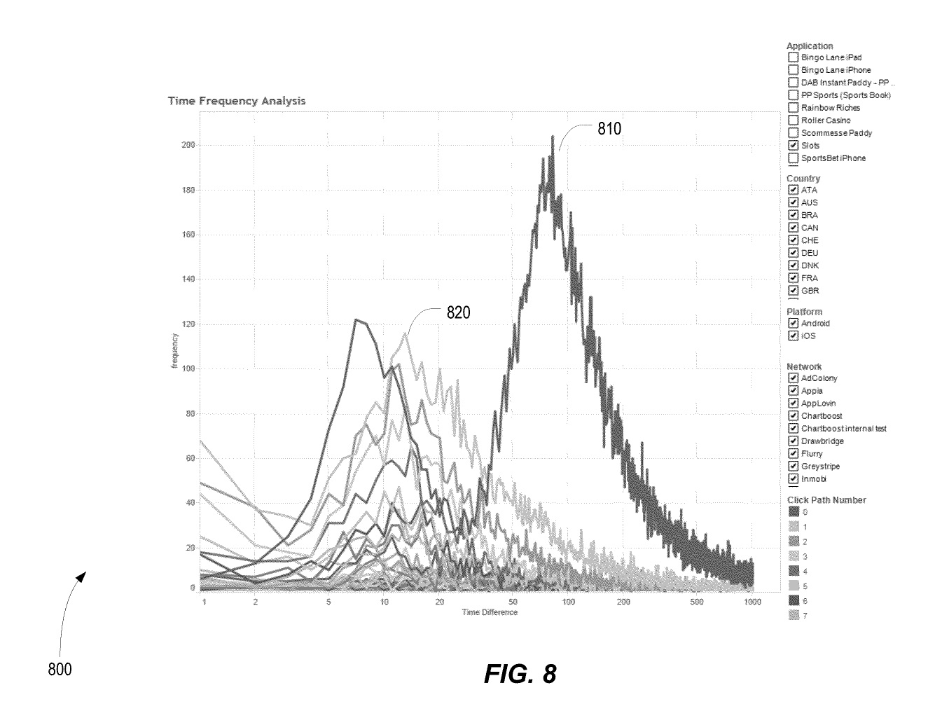

FIG. 8 shows an exemplary visualization 800 of data according to embodiments of the present invention. The visualization includes a graph that plots data by time difference (x-axis) and frequency (y-axis). Each graph line may correspond to a total number of clicks that were made before an in-app event was completed. For example, graph line 810 represents “Click Path 0,” corresponding to 0 clicks that were made before an in-app event was completed and graph line 820 represents ‘Click Path 1,” corresponding to 1 click that was made before an in-app event was completed.

Each graph line may plot the frequency of click paths with the total number of clicks and the time is takes for this click path to occur. For example, graph line 810 plots the frequency of click paths with 0 clicks that were made before the in-app event was completed against the time it took for these click paths to occur. Graph line 820 plots the frequency of click paths with 1 click that was made before the in-app event against the time it took for these click paths to occur. This visualization can allow campaign buyers (e.g., marketers) to determine the most frequent length (e.g., number of clicks) in a click path and how long it takes on average for click paths with a certain click path length to occur.

FIG. 9 shows a sample visualization 900 of data related to click path analysis according to embodiments of the present invention. FIG. 9 shows a graph with data plotted by click type (x-axis) and % of traffic by click type (y-axis). The visualization shows information related to click events of certain click types including first clicks 910, contributing clicks 920, assisting clicks 930, and converting clicks 940. The visualization indicates, for each click type, the percentage of traffic that is a media type of video, incentivized media, demand-side platform (DSP), display network, and app promotion network. In some embodiments, the data in the graph of FIG. 9 may be for click data associated with one or more mobile devices over a time period for a display campaign associated with a media partner.

The data in FIG. 9 is useful in analyzing what media types may be effective for the display campaign. Typically, only data for the converting clicks 940 may be accessible. In this case, one may recognize that the most traffic arises from display campaigns of a video type. However, data from typical analyses may not omit duplicates, which can further make the analyses ineffective. Hence, typical analyses do not provide a full picture of other media types that may be effective for other click event types, such as in first clicks 910, contributing click 920, and assisting clicks 930.

Embodiments of the present invention enable visibility of data associated with clicks prior to the converting clicks, which can allow more effective analysis. In one exemplary analysis, a user of the visualization program may recognize from the visualization that for the first clicks, contributing clicks, and assisting clicks, a display campaign of a video type does not bring as much traffic as it does for converting clicks. Instead, campaigns of a DSP type are shown to be effective, making up 28% of the first clicks, 30% of the contributing clicks, and 23% of the assisting clicks. Thus, the user of the visualization program may recognize that display campaigns of DSP type may be worth spending money on, since a significant portion of preceding click events originate from a DSP type campaign. This conclusion would not have been likely had the user only been able to see data for converting clicks, which shows that a mere 8% of traffic is of DSP type. Other suitable analyses based on data presented in FIG. 9 may be conducted as well, for example, by categorizing first clicks 910, contributing clicks 920, assisting clicks 930, and converting clicks 940 by country or by another category.

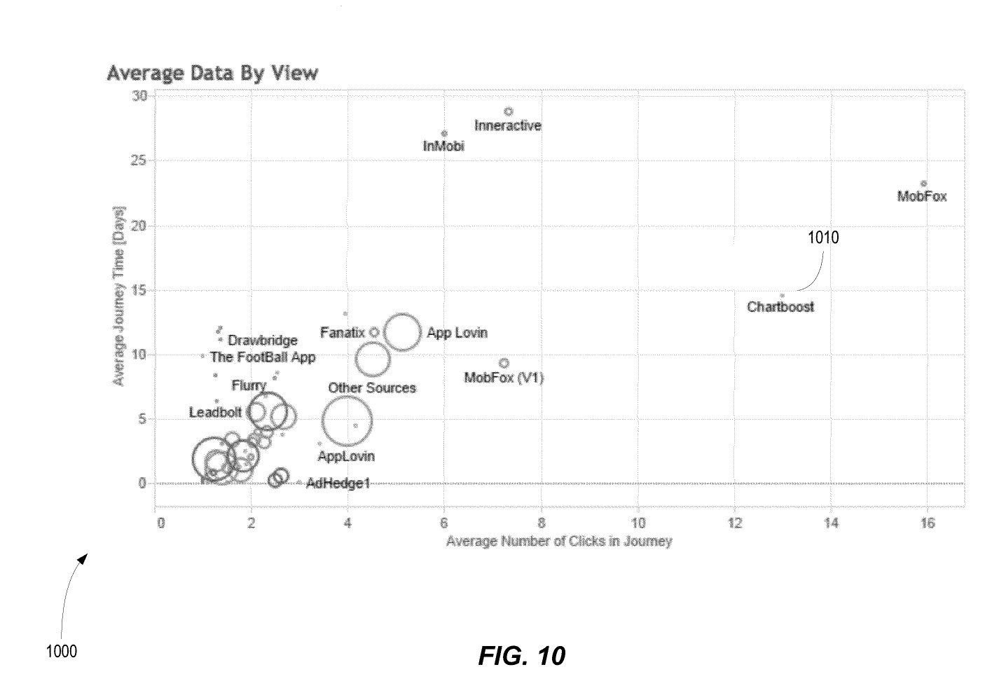

FIG. 10 shows a sample visualization 1000 of data related to click path analysis according to embodiments of the present invention. FIG. 10 shows a graph with data plotted by average number of clicks in journey (x-axis) and average journey time (y-axis), with the size of each “bubble” of data in the graph representing frequency of a given in-app conversion. With all time-stamped click events in a user's journey grouped together, FIG. 10 shows an overall journey length, in terms of number of clicks and time. For example, a user of the visualization program may recognize that the journey associated with the “Chartboost” display campaign 1010 has an average journey of roughly 13 clicks over around 15 days. The small size of the bubble corresponding to “Chartboost” display campaign 1010 may show that the frequency of an in-app conversion is low. This information can be important to campaign buyers (e.g., advertisers), to indicate to them how much time they should allow before implementing optimizations and make decisions based on the performance on the campaign. Hence, the visibility of the journey length can show how much time may elapse for a display campaign to take effect.

For campaign buyers, the result of the click path analysis can give enhanced visibility into campaign performance. This can give them the confidence to spend more money on certain areas of their mobile display campaigns (e.g., campaigns of a certain media type), and to make the insights gained actionable, so that mobile display campaigns may be optimized for improved results based on the collected data.

3. Click Path Analysis Uses

Click path analysis may be utilized to provide insights as to how campaign buyers can optimize their spending on ad campaigns. Campaign buyers desire to have tools of visibility that give them confidence to spend more money in mobile campaigns, and then to optimize and improve results based on the data collected.

After click path analysis is performed, results of the analysis may be reported back to campaign buyers, which can provide insights about actions that may be taken on media spend. In some embodiments, campaign buyers may conduct modelling on potential scenarios based on the received analysis results. For example, campaign buyers may model a first scenario in which campaigns of all media sources are equally utilized in a click path. In another example, campaign buyers may model a second scenario in which media sources that bring the most unique traffic in converting clicks are increased earlier in a click path, prior to the converting click.

Campaign buyers may then perform trials on their modelled scenarios. For example, trials for the first scenario may apply the same percentage of spend for campaigns with certain media sources for all clicks (e.g., first clicks, assisting clicks, contributing clicks, and converting click) in a click path. Trials for the second scenario may increase spend for campaigns with media sources that brought the most unique traffic in converting clicks, indicated by the click path analysis results, earlier in a click path. For example, if campaigns with video brought the most unique traffic for converting clicks, campaigns with video may be increased for expected first clicks, assisting clicks, and contributing clicks in the click path.

Campaign buyers may then determine whether more clicks were converted based on the trials for different scenarios. In some cases, the converting click may lead to a sale, registration, upgrade, or any other possible in-app event. Hence, an increased number of converted clicks in a trial scenario may result in increased sales, enrollments, and upgrades, which may indicate to campaign buyers that the tested scenario is effective. Any other suitable scenarios not described herein may also be modelled and tested.

Once trials are completed, alternative attribution models can be finalized and added to ongoing campaign reporting. Campaign buyers may update their media spend based on the results of their trials and continue to monitor certain scenarios by the provided click path analysis. Thus, click path analysis data enables campaign buyers to optimize and improve their campaign results based on a more comprehensive view of clicks leading to in-app events.

### IV. System Architecture for Data Collection/Processing

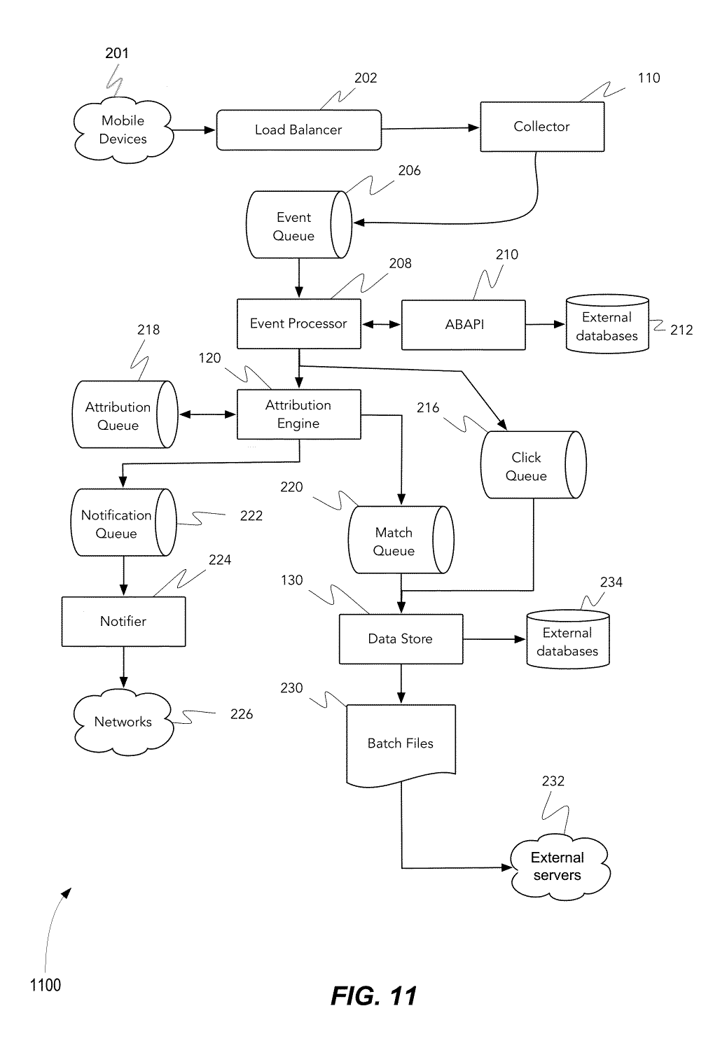

FIG. 11 shows an exemplary architecture 1100 for data collection and data attribution according to embodiments of the present invention.

As depicted in FIG. 11, when users conduct one or more click events on a plurality of mobile devices 201, a load balancer 202 may receive click data associated with the click events for stability purposes. Load balancer 202 may be a device that distributes network or application traffic in order to improve performance of an application and decrease the load on collector 110. Collector 110 may be a server computer that can receive the click data from the load balancer 202, to register the event. In some cases, upon registering, the click data may be associated with a timestamp at which the click occurred.

The click data may then be received at an event queue 206. Event queue 206 may be one or more databases that hold event-related data and stores the click data in a chronological (e.g., FIFO queue). Event queue 206 may send the click data to an event processor 208 in the order that data was received from collector 110. The event processor 208 may then process the click data. This system architecture can allow for greater stability with fully independent components handling each part of the process.

In some embodiments, event data (click event data and SDK event data) can be processed on parallel lines, such as through an ABAPI (business API) 210 to external databases 212, through an attribution engine 120 for SDK Events, and to a click queue 216. In some cases, the event data may be processed on parallel lines depending on the type of event. For example, SDK event data may be passed to attribution engine 120 and click event data may be passed to click queue 216. The ABAPI 210 may house application and campaign information (e.g., campaign identifiers, publishers, media sources, etc.) related to particular click events and SDK events. This information can be utilized when each event is processed. In some cases, data may be passed along to external databases 212 through ABAPI 210 in order to combine rich campaign information with raw event data for storage and further processing. For example, campaign information (e.g., campaign identifier) from ABAPI 210 associated with an event may be stored in association with event data of the event being processed.

An attribution queue 218 may temporarily store data until the data can be processed by attribution engine 120. This may prevent the systems of attribution engine 120 from becoming overloaded. Data may be sent from attribution queue 218 to attribution engine 120 as appropriate, depending on the load of attribution engine 120. Upon receiving the data, attribution engine 120 may create a connection between a click event and an SDK event (e.g., track the events to a single mobile device).

Attribution engine 120 may process SDK Events and search for click events originating at a single mobile device within a predefined time frame (an “attribution window”). If a match is found, the events are passed to a match queue 220. After processing the event data, the attribution result (e.g., Click ID or “NO MATCH”) may be nested into the data of the event.

When an SDK event is matched to a click event (i.e., a “conversion” has taken place), any parties that may desire to be notified about the conversion are identified (e.g., certain third party networks 226). Settings related to notification rules may be stored by ABAPI 210, based on the matched SDK event. For example, certain parties may have signed up to receive notifications when a certain type of SDK event is tracked. Such information may be accessed through ABAPI 20. After attribution engine 120 collects information from ABAPI 20, attribution engine 120 may send out commands to a notifier 224 to make certain calls for specific networks about the conversion. In some embodiments, the commands may be held at a notification queue 222 to avoid overloading systems of notifier 224. Notification queue 222 may send commands to notifier 224 as appropriate, based on the load of notifier 224.

Data, in both raw and processed form, may be stored at a data store 130. Data store 130 may be one or more databases or any suitable storage structure. Processed event data from data store 130 may be utilized for various purposes, such as for visualization in a graphical user interface and report generation. Before raw data is processed, it may exist as batch files 230, which may have a raw format that may be sent to external servers 232 for storage and analysis (e.g. click fraud and click categorization/click path analysis). External servers 232 may also provide redundancy (e.g., data backup) for the system, which may increase reliability of the system. Processed data may be sent to one or more external databases 234 to be utilized for analysis.

Any of the computing devices included in FIG. 11, (e.g., mobile devices 201, load balancer 202, collector 110, event processor 208, attribution engine 120, notifier 224, etc.) may include a processor and a computer-readable medium coupled to the processor. The computer-readable medium may comprise instructions, that when executed by the processor, perform any of the methods described herein.

### V. User Request Fulfillment

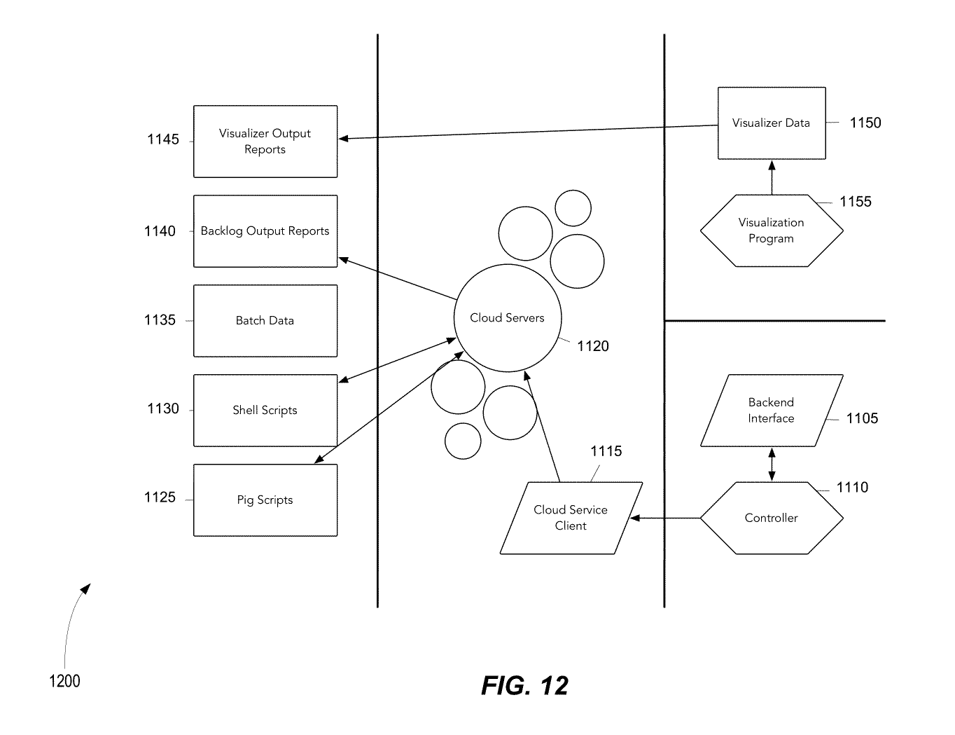

Certain embodiments of the present invention fulfill user requests as described with respect to system 1200 of FIG. 12.

In order to run analyses on large amounts of data within an acceptable time, scripts that contain relevant algorithms and resources may be received via a backend interface 1105. The data input into the backend interface 1105 may activate a controller 1110, which may run an analysis following a predefined order and may bring the requested resources into action.

The controller 1110 may build up analysis for computer calculation. Based on configurations that controller 1110 requests, one or more cloud servers 1120 may be built up in the cloud via a cloud service client 1115 to retrieve click events, SDK events, and scripts to run, and then carry out the calculations.

Controller 1110 may retrieve code when the cloud servers 1120 are ready. The code may be pig scripts 1125 and shell scripts 1130 that include scripts that may be run for click fraud analysis. Pig scripts 1125 and shell scripts 1130 may be executed, which can instruct cloud service client 1115 to build data (e.g. SDK and click events). When a whole data set is built up, batch data 1135 may be filtered down and the requested output may be compiled.

The end result is a new set of visualizer data 1150 that may be stored in the cloud-based storage solution, where it may be accessed by a data visualization program 1155 to create visualizer output reports 1145 and backlog output reports 1140 for users of the data visualization program (e.g., campaign buyers that would like to analyze their click traffic). A web interface may be utilized to interact with the dataset in order to create different reports and visualizations based on the dataset.

### VI. Computer System

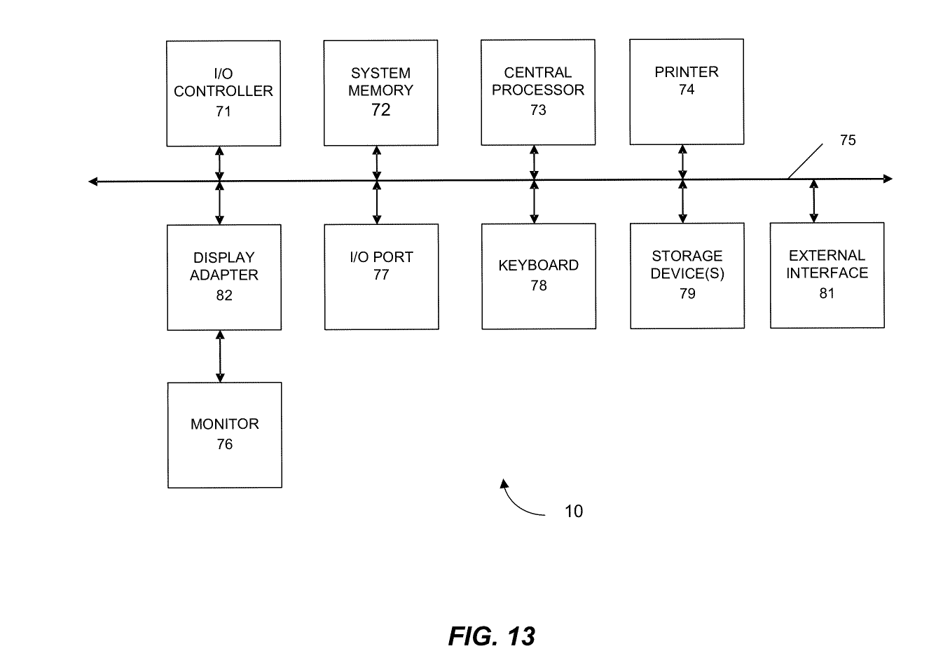

Any of the computer systems mentioned herein may utilize any suitable number of subsystems. Examples of such subsystems are shown in FIG. 13 in computer apparatus 10. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 13 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

A computer system can include a plurality of the same components or subsystems, e.g., connected together by external interface 81 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned here are incorporated by reference in their entirety for all purposes. None is admitted to be prior art.

What is claimed is:

1. A method comprising, performing by a server computer:
receiving data related to a plurality of click events occurring at a plurality of mobile devices, the click events including clicking on a plurality of links associated with a plurality of display campaigns, wherein click data of each click event include at least one device identifier of a mobile device and a campaign identifier, wherein each mobile device is associated with a unique master identifier;
for each of the plurality of click events:
storing the click data in a click data record in a database;
conducting an analysis for a first mobile device comprising:
receiving in-app data of an in-app event of the first mobile device, the in-app data including a first device identifier, wherein the in-app event includes a first opening of a mobile application by a user or an activity with the mobile application that occurs while the mobile application is in use;
generating hashed versions of the first device identifier associated with the first mobile device;
storing, in a first device data record of the database, the first device identifier and the hashed versions of the first device identifier in association with a first master identifier corresponding to the first mobile device and in association with the in-app data of the in-app event;
accessing the first device data record and the click data records to compare the at least one device identifier included in click data for at least a portion of the click events with one or more of the hashed versions of the first device identifier associated with the first master identifier;
determining at least one click event from the click events that includes the at least one device identifier that matches at least one of the hashed versions of the first device identifier associated with the first master identifier corresponding to the first mobile device; and
storing the click data for the at least one click event in the first device data record of the database in association with the first master identifier, the in-app data of the in-app event, and the click data for click events related to the first mobile device.

2. The method of claim 1, further comprising:
conducting the analysis for each of the plurality of mobile devices.

3. The method of claim 2, further comprising:
accessing the database to identify click data records storing click data including a first campaign identifier associated with a first display campaign from the plurality of display campaigns;
determining an amount of the identified click data records to determine a total count of click events associated with the first display campaign;
accessing the database to identify device data records storing the click data stored by the identified click data records, wherein each device data record is associated with a unique master identifier;
determining a number of the identified device data records; and
obtaining a quality score based on the determined number of identified device data records and the total count of click events.

4. The method of claim 3, wherein the quality score is obtained by dividing the determined number of device data records by the total count of click events.

5. The method of claim 3, further comprising:
identifying whether the quality score is below a threshold; and
sending, to a computing device operated by a campaign buyer associated with the first display campaign, an alert if the quality score is below the threshold.

6. The method of claim 3, further comprising:
tracking the quality score based on one or more categories, the one or more categories including at least one of: a specific country, a media partner, an operating system type, a browser type, and a geographic location.

7. The method of claim 1, wherein the click data for each of the plurality of click events and the in-app data for the in-app event includes a timestamp.

8. The method of claim 7, further comprising:
accessing the first device data record to identify the click events related to the first mobile device;
determining one or more preceding click events from the identified click events, wherein click data of each of the one or more preceding click events includes a timestamp that occurs earlier than the timestamp included in the in-app data for the in-app event; and
determining a chronological order of the preceding click events.

9. The method of claim 8, further comprising:
determining a total number of the preceding click events;
determining a first click event from the preceding click events with click data including a first timestamp that occurs first out of the preceding click events;
determining a second click event from the preceding click events with click data including a second timestamp that occurs last out of the preceding click events;
determining a time period over which the preceding click events occurred by calculating the time difference between the second timestamp and the first timestamp; and
providing the total number of the preceding click events and the determined time period to a computing device of a campaign buyer.

10. The method of claim 8, further comprising:
categorizing the preceding click events based on one or more categories, the one or more categories including at least one of: a click type, a media source, a publisher, and networks.

11. A server computer comprising:
a processor;
a computer-readable medium coupled to the processor, the computer-readable medium comprising instructions, that when executed by the processor, perform:
receiving data related to a plurality of click events occurring at a plurality of mobile devices, the click events including clicking on a plurality of links associated with a plurality of display campaigns, wherein click data of each click event include at least one device identifier of a mobile device and a campaign identifier, wherein each mobile device is associated with a unique master identifier;
for each of the plurality of click events:
storing the click data in a click data record in a database;
conducting an analysis for a first mobile device comprising:
receiving in-app data of an in-app event of the first mobile device, the in-app data including a first device identifier, wherein the in-app event includes a first opening of a mobile application by a user or an activity with the mobile application that occurs while the mobile application is in use;
generating hashed versions of the first device identifier associated with the first mobile device;
storing, in a first device data record of the database, the first device identifier and the hashed versions of the first device identifier in association with a first master identifier corresponding to the first mobile device and in association with the in-app data of the in-app event;
accessing the first device data record and the click data records to compare the at least one device identifier included in click data for at least a portion of the click events with one or more of the hashed versions of the first device identifier associated with the first master identifier;
determining at least one click event from the click events that includes the at least one device identifier that matches at least one of the hashed versions of the first device identifier associated with the first master identifier corresponding to the first mobile device; and
storing the click data for the at least one click event in the first device data record of the database in association with the first master identifier, the in-app data of the in-app event, and the click data for click events related to the first mobile device.

12. The server computer of claim 11, wherein the instructions, that when executed by the processor, further perform:
conducting the analysis for each of the plurality of mobile devices.

13. The server computer of claim 12, wherein the instructions, that when executed by the processor, further perform:
accessing the database to identify click data records storing click data including a first campaign identifier associated with a first display campaign from the plurality of display campaigns;
determining an amount of the identified click data records to determine a total count of click events associated with the first display campaign;
accessing the database to identify device data records storing the click data stored by the identified click data records, wherein each device data record is associated with a unique master identifier;
determining a number of the identified device data records; and
obtaining a quality score based on the determined number of identified device data records and the total count of click events.

14. The server computer of claim 13, wherein the quality score is obtained by dividing the determined number of device data records by the total count of click events.

15. The server computer of claim 13, wherein the instructions, that when executed by the processor, further perform:
identifying whether the quality score is below a threshold; and
sending, to a computing device operated by a campaign buyer associated with the first display campaign, an alert if the quality score is below the threshold.

16. The server computer of claim 13, wherein the instructions, that when executed by the processor, further perform:
tracking the quality score based on one or more categories, the one or more categories including at least one of: a specific country, a media partner, an operating system type, a browser type, and a geographic location.

17. The server computer of claim 11, wherein the click data for each of the plurality of click events and the in-app data for the in-app event includes a timestamp.

18. The server computer of claim 17, wherein the instructions, that when executed by the processor, further perform:
accessing the first device data record to identify the click events related to the first mobile device;
determining one or more preceding click events from the identified click events, wherein click data of each of the one or more preceding click events includes a timestamp that occurs earlier than the timestamp included in the in-app data for the in-app event; and
determining a chronological order of the preceding click events.

19. The server computer of claim 18, wherein the instructions, that when executed by the processor, further perform:
determining a total number of the preceding click events;
determining a first click event from the preceding click events with click data including a first timestamp that occurs first out of the preceding click events;
determining a second click event from the preceding click events with click data including a second timestamp that occurs last out of the preceding click events;
determining a time period over which the preceding click events occurred by calculating the time difference between the second timestamp and the first timestamp; and
providing the total number of the preceding click events and the determined time period to a computing device of a campaign buyer.

20. The server computer of claim 18, wherein the instructions, that when executed by the processor, further perform:
categorizing the preceding click events based on one or more categories, the one or more categories including at least one of: a click type, a media source, a publisher, and networks.
